(19) United States
(12) Patent Application Publication
(10) Pub. No.: US 2009/0125719 A1
(43) Pub. Date: May 14, 2009

(54) METHODS OF ENSURING LEGITIMATE PAY-PER-CLICK ADVERTISING

(76) Inventors: William Cochran, Champaign, IL (US); Stuart Stubblebine, Madison, NJ (US)

Correspondence Address: MICHAEL BEST & FRIEDRICH LLP, 100 E WISCONSIN AVENUE, Suite 3300, MILWAUKEE, WI, 53202, US

(21) Appl. No.: 12/139,938

(22) Filed: Jun. 16, 2008

Related U.S. Application Data
(60) Provisional application No. 60/963,149, filed on Aug. 2, 2007.

(51) Int. Cl. H04L 9/00; G06F 15/16

(52) U.S. Cl. 713/171; 709/203

(57) ABSTRACT

A method for transferring state information between a client device and a server, the client device being configured to select content, and the server having a memory module and being configured to store referenced content and to transmit referenced content to at least one client device. The method includes receiving a request on the server from the client device, wherein the request includes the state information from the client device; detecting whether the state information has previously been received by the server; updating the state information; and transmitting a response including the updated state information to the client device.

### CROSS-REFERENCE TO RELATED APPLICATIONS

This application claims priority to U.S. Provisional Application No. 60/963,149, filed Aug. 2, 2007, which is incorporated herein by reference in its entirety. This application is related to U.S. patent application Ser. No. ______ to Cochran et al. entitled “Graphical User Interface and Methods of Ensuring Legitimate Pay-Per-Click Advertising,” filed Jun. 16, 2008 (Attorney Docket No. 048531-9014-US02), incorporated herein by reference in its entirety.

### FIELD OF THE INVENTION

The present invention relates to tracking online advertising and in particular to methods for assessing whether online advertising activity is legitimate.

### BACKGROUND OF THE INVENTION

Since the inception of the World Wide Web, many people have tried to harness its advertising potential. One method for harnessing this is the pay-per-click advertising model. However, many pay-per-click business models are susceptible to abuse.

Under a typical pay-per-click advertising model, advertisers agree to pay a server configured to provide linked advertisements on commercial web sites (a “content server”) for advertising that is presented to specific demographic groups. The content server places the advertiser's advertisements on the web sites where they are clicked by individuals seeking more information about the advertisers and their goods and services. Generally, under the terms of the agreement, the advertiser agrees to pay the content server a small fee each time a user clicks on one of the advertiser's advertisements. The content server then compensates the web site that presented the advertisement.

This model has at least two deficiencies: 1) there is no mechanism to reliably detect and account for web site operators who click on advertisements served on their web pages, and 2) there is no system that ensures that appropriate advertisements are served to a particular web page. Without explicit prevention, users of pay-per-click advertising models must trust the content server to isolate and remedy fraudulent clicks.

As an example of a common type of fraud associated with pay-per-click advertising models, certain malicious individuals may set up web sites designed to look like credible web sites that might contain information about a particular product or industry. For example, such an individual could lease a domain name that is a common misspelling of the domain name of a credible web site.

Once such a site is set up, malicious individuals can wait for users to find the web site and click on the advertisements (a legitimate business model) or manufacture clicks using known mechanisms. For instance, in some countries it is cost effective to hire people to click on advertisements on these web sites. No matter what mechanism is used, the result is that the advertiser is paying for clicks by Internet users that have no intention of viewing the advertiser's web content.

One remedy to this situation is for the content server to recognize what is transpiring. Certain web usage patterns are easy to identify and many who attempt to defraud pay-per-click advertising models are caught. However, for some advertisers this is not an adequate solution because the fraudulent activities are not discovered until a relatively long time after they have occurred and the advertiser must rely on the content server to alert them to the activity. Therefore, it would be useful to have a system that allows for Internet advertisers to detect fraudulent clicks on their advertisements in real time so that the advertiser can contact the content server and report the fraudulent activity immediately.

Another concern with pay-per-click advertising models involves advertisements that appear on a competitor's web site. Many commercial web site owners use content servers to place advertisements on their own web sites. However, it is also possible that a competitor's advertisement will be served to their web site. Such a scenario is unpalatable for the commercial web site owner because it allows a competitor to advertise its products and services using the web site and resources of the commercial web site owner. Content servers have developed very sophisticated algorithms to prevent this from occurring. However, in some cases the only way for a commercial web site owner to verify the results of these algorithms is to frequently click on all of the advertisements served to its web site to ensure that none belong to its competitors. Distinguishing between those looking for competitors on their web site and those driving up the number of advertisement clicks on their web site is not possible within the framework of current pay-per-click advertising models. Therefore, it would be useful to have a system which permits advertisers to verify that its competitor's advertisements are not displayed on its web site, without being accused of committing click fraud.

### SUMMARY OF THE INVENTION

An improved system would allow advertisers to identify bad-faith clicks on their advertisements as they happen so that they can be promptly discounted. If they are promptly discounted, then owners of commercial web sites can verify the ads placed on their sites without worrying about being declared fraudulent after the fact. The immediacy of the determination means content servers will not collect and distribute money based on bad faith clicks.

Embodiments of the invention approach these problems by establishing non-intrusive protocols requiring that browsers perform a small amount of work before they present an advertisement to an Internet user. The protocols provide for the transfer of secure information between the browser and the content server. This information can be used to store metrics that provide insight into an Internet user's intent when they click or select an advertisement. Furthermore, these protocols require that content servers provide receipts to advertisers at the time that an advertisement is clicked. These receipts contain information that the advertiser can use to determine the legitimacy of clicks on its advertisements. The protocols presented by embodiments of the invention provide tradeoffs between features and complexity. These protocols are relatively lightweight, and can be implemented using common and well understood web development tools such as the Common Gateway Interface (“CGI”) for server side processing and AJAX or Javascript on the browser side. Persistent data can be stored at the client in cookies (such as HTTP cookies) and in databases at the server side.

Embodiments of the invention provide methods, systems, and apparatuses for discerning the legitimacy of a click on an advertisement by the user of a browser. In particular, embodiments of the invention provide methods and systems for using encrypted data to store information concerning the interactions between a browser and a server, and a mutating identifier which the server uses to decrypt the data. At least two protocols are implemented: an Ad Presentation Protocol and an Ad Click Protocol.

In one embodiment, the Ad Presentation Protocol commences when a device configured to use a browser communicates with a content server. If the browser has communicated with the server previously the device will have encrypted data, containing information about the past interactions between the content server and the browser, and an unencrypted identifier stored in its memory. The browser transmits these items to the content server along with the request.

The content server receives the request from the browser. If the browser transmitted the encrypted data and an unencrypted identifier, the content server uses the unencrypted identifier to look up a key stored in its memory. The server uses the key to decrypt the data and updates the data with additional information about this interaction between the browser and the content server. The content server generates another identifier/key pair, re-encrypts the updated data using the key, and stores the key so that it can be located using the identifier at a later time. The content server transmits the encrypted updated data and the unencrypted new identifier to the browser along with instructions telling the browser to request a web page from the advertiser's web server.

If the browser has not previously transmitted the encrypted data and an unencrypted identifier, then the transaction is treated as a first interaction between the browser and the content server. In this case, the content server creates a new set of data containing information regarding only this interaction between the content server and the browser. The content server generates a new identifier/key pair, uses the new key to encrypt the data, and stores the new key so that it can be located using the new identifier at a later time. The content server transmits the encrypted new data and the unencrypted new identifier to the browser, along with instructions telling the browser to request a web page from the advertiser's web server.

The Ad Click Protocol commences when a user of a device configured to use a browser clicks on a linked advertisement and the browser transmits a request to the content server. This request contains the encrypted data, which includes information regarding the past interactions between the content server and the browser, and the unencrypted identifier.

The content server receives the request from the browser and uses the unencrypted identifier to look up a key stored in its memory. The content server uses the key to decrypt the data and updates the data with additional information about this interaction between the browser and the content server. The content server generates a new identifier/key pair, re-encrypts the updated data using the new key, and stores the new key so that it can be located using the identifier at a later time. The old identifier/key pair may be deleted from the content server's memory.

In addition, as part of the Ad Click Protocol, the content server prepares a receipt for the advertiser. This receipt contains information that the advertiser uses to determine the legitimacy of a user click on its advertisements in real-time. The content server compiles the information for the receipt using the data which it extracts from the encrypted data and, in some embodiments, from data that is the stored in the content server's memory. The content server stores the receipt in its memory along with a unique identifier.

The content server transmits a response to the browser. This response contains the encrypted data and the unencrypted identifier, the unique identifier for the receipt, and instructions for the browser.

The browser receives the response and stores the encrypted data and unencrypted identifier into the memory of the device. The browser sends a request to the advertiser, forwarding the instructions and the identifier for the receipt.

The advertiser receives the identifier for the receipt and subsequently contacts the content server and requests the receipt using the identifier. The content server locates the receipt that is associated with the identifier and transmits the receipt to the advertiser. The receipt is parsed and the advertiser analyzes the data provided by the content server, as described below, to determine whether the click on the advertisement was legitimate. If the advertiser determines that the click was not legitimate, it can notify the content server immediately. In addition, in response to the request, the advertiser transmits a response to the browser containing an HTML encoded web page.

Alternatively, the content server can contact the advertiser directly rather than through the browser.

In addition to the Ad Presentation Protocol and the Ad Click Protocol, some embodiments of the invention implement additional protocols. The protocols provide the advertiser with information concerning the intent of a user who clicks on an advertisement. In one embodiment, a Time Metric Protocol is implemented. This protocol is designed to measure the amount of time that a browser spends on an advertiser's web site. This protocol requires the browser to contact the content server a set number of seconds after each iteration of the Ad Click Protocol. This provides the advertiser and the content server with an indication of whether the user is spending a minimum amount of time on the advertiser's web site or whether the user is merely clicking on Internet advertisements.

In other embodiments, the invention implements a Ratio Metric Protocol. This protocol is designed to isolate browsers that have an extremely high number of advertisement clicks with respect to the number of commercial web sites visited. This metric is implemented by maintaining two counters in the encrypted data stored on the browser. The first counter is incremented for each iteration of the Ad Presentation Protocol and the second counter is incremented for each iteration of the Ad Click Protocol. These counters are transmitted to the advertiser as part of the Ad Click Protocol, allowing the advertiser to identify browsers that have a high number of Ad Click Protocol iterations compared to the number of Ad Presentation Protocol iterations. This provides the advertiser and the content server with an indication of whether the user is clicking on more advertisements than usual in comparison with the number of commercial web sites that they visit.

In another embodiment, the invention may implement a Refresh Metric Protocol. This metric is designed to count the number of times that a user causes the browser to load a commercial web site, perhaps in an attempt to circumvent the Ratio Metric Protocol. The Refresh Metric Protocol is implemented by causing a counter that is incremented for each iteration of the Ad Presentation Protocol and the time between iterations of the Ad Presentation Protocol to be maintained in the encrypted data. Using this information, the advertiser and the content server can identify browsers that have a higher number of Ad Presentation Protocol iterations over a given period than is usual. The advertiser can immediately report this activity to the content server.

In yet another embodiment, the invention may implement a Repeat Metric Protocol. This protocol is designed to capture the variability of Internet advertisement use. The Repeat Metric Protocol helps provide a tool to penalize web browsers that predominately click advertisements from a small number of web sites. This protocol is the most expensive in terms of data storage. For each iteration of the Ad Click Protocol, the content server maintains a record of the web sites on which the user has clicked linked advertisements. Summary data from this record is transmitted to the advertiser after a predetermined time period. The advertiser and the content server use this information to identify browsers with a disproportionately high number of clicks on linked advertisements for a particular web site.

In one embodiment, the invention is a method for transferring state information between a client device and a server, the client device being configured to select content, and the server having a memory module and being configured to store referenced content and to transmit referenced content to at least one client device. The method includes receiving a request on the server from the client device, wherein the request includes the state information from the client device; detecting whether the state information has previously been received by the server; updating the state information; and transmitting a response including the updated state information to the client device.

In another embodiment, the invention is a method for transferring encrypted data between a client device configured to select advertisements by the use of a user agent and a server configured with a memory module and to store linked advertisements and transmit linked advertisements to at least one client device. The method includes receiving a request and encrypted data from the client device; decrypting the encrypted data using a first key stored in the memory module of the server to produce unencrypted data; updating the unencrypted data with information regarding at least one of the user agent, the client device, and the linked advertisement; generating a second key on the server and using the second key to encrypt the updated unencrypted data instead of the first key; encrypting the updated unencrypted data using the second key to produce re-encrypted data; and transmitting a response and the re-encrypted data to the client device.

In yet another embodiment, the invention is a method of transferring information between a first server and a second server, the first server configured to store referenced content and to transmit referenced content to at least one client device. The method includes providing state information; transmitting a first request and the state information to the first server in response to the client device; receiving the first request and state information on the first server; and transferring the state information to the second server.

In still another embodiment, the invention is a method of transferring information between a first computer and a second computer, the first computer configured to store linked advertisements and to transmit linked advertisements to at least one client device. The method includes the first computer receiving a mutating cookie from the client device, wherein the mutating cookie comprises encrypted information; receiving the first request and mutating cookie on the first computer; decrypting the encrypted information included in the mutating cookie on the first computer to create unencrypted data; generating a receipt comprising information pertaining to at least one of the client device, the first computer, and the unencrypted data; and transferring the receipt to the second computer.

In yet another embodiment, the invention is a system for transferring encrypted data. The system includes a first server having a memory module; and a client device having a memory module and configured to run a user agent that is configured to select linked advertisements. The client device is further configured to store encrypted data in the memory module, transmit a request and the encrypted data to the first server in response to the user agent, and receive encrypted updated data and store it in the memory module. The server is configured to store and transmit linked advertisements, receive the request and the encrypted data, locate a first key in the memory module, use the first key to decrypt the encrypted data to generate unencrypted data, update the unencrypted data with additional information regarding the client device, the server, linked advertisements, or a combination of the same to create updated data, use the first key to encrypt the updated data, and transmit a response and the encrypted updated data to the client device.

In still another embodiment, the invention is a system for transferring data between a first server and a second server. The system includes a client device configured to run a user agent that is capable of selecting linked advertisements, transmit a first request to the first server, receive a first response and an identifier from the first server, and transmit a second request and the identifier to the second server. The first server is configured to store linked advertisements and transmit them to at least one client device, receive the first request from the client device and generate data regarding the user agent, the client device, the first server, the linked advertisements, or a combination of the same, generate an identifier and associate the identifier with the data in its memory module such that the data may be retrieved using the identifier, transmit the first response and the identifier to the client device, receive a third request and the identifier from the second server, use the identifier to locate the data on its memory module, and transmit a second response which contains the data to the second server. The second server configured to receive the second request and the identifier from the client device, transmit the third request and the identifier to the first server, and receive the second response and the data from the first server.

In yet another embodiment, the invention is a server for storing and transmitting linked advertisements. The server includes a memory module configured to store linked advertisements and a number of keys; an input/output module configured to transmit linked advertisements to one or more client devices, receive encrypted data from at least one of the one or more client devices which has selected a linked advertisement, and transmit encrypted updated data to the at least one client device over at least one communication link; and a processor configured to a locate at lease one of the number of keys stored in the memory module, decrypt the encrypted data using the at least one of the number of keys, update the data with information regarding the client device, server, the linked advertisements, or combination of the same, and encrypt the updated data.

In still another embodiment, the invention is a client device for selecting linked advertisements. The client device includes a memory module configured to store encrypted data; an input/output module configured to receive encrypted data from a server over at least one communication link and to transmit encrypted data to at least one server over at least one communication link at the request of a user agent running on the client device and which is capable of selecting linked advertisements; and a processor configured to run the user agent, cause the memory module to store encrypted data when it is received from the server, and cause the memory module to retrieve the encrypted data.

In yet another embodiment, the invention is a method of determining the legitimacy of the selection of a linked advertisement. The method includes implementing an advertisement presentation protocol, wherein the protocol includes transmitting a mutating cookie between a user agent and a content server; configuring the mutating cookie to include encrypted data concerning the interactions between the content server and the user agent; associating an unencrypted identifier with a cryptographic key for storing on the content server; and exchanging the mutating cookie between the user agent and the server each time the browser visits a new web site.

In still another embodiment, the invention is a method of determining the legitimacy of the selection of a linked advertisement. The method includes transmitting a cookie from a user agent to a content server; updating information in the cookie at the content server; generating a receipt configured for an advertiser, the receipt including information pertaining to activity of a user who selects a linked advertisement; analyzing the receipt; and generating an alert based on the analysis of the receipt.

### BRIEF DESCRIPTION OF THE DRAWINGS

In the drawings:

FIG. 1 schematically illustrates a system for discerning the intent of clicks on a linked advertisement according to one embodiment of the invention.

FIG. 2 schematically illustrates one implementation of the Ad Presentation Protocol by the system of FIG. 1.

FIG. 3 depicts a lookup table used during the protocols described in FIGS. 2 and 5.

FIG. 4A depicts the contents of one type of mutating cookie that can be used in the protocols of FIGS. 2 and 5.

FIG. 4B depicts the contents of another type of mutating cookie that can be used in the protocols of FIGS. 2 and 5.

FIG. 5 schematically illustrates one implementation of the Ad Click Protocol.

FIG. 6 schematically illustrates an alternative of the Ad Click Protocol.

FIGS. 7A-7J depict pages corresponding to an exemplary web interface by which an advertiser can set parameters related to the system.

### DETAILED DESCRIPTION

Before embodiments of the invention are explained in detail, it is to be understood that the invention is not limited in its application to the details of the construction and the arrangements of the components set forth in the following description or illustrated in the drawings. The invention is capable of still other embodiments and of being practiced or being carried out in various ways.

In particular, it should be understood that some embodiments are implemented using various computer devices, such as personal or home computers, servers, and other devices that have processors or that are capable of executing programs or sets of instructions, including special-purpose devices, such as cell phones and PDA's. In general, some embodiments may be implemented using existing hardware or hardware that could be readily created by those of ordinary skill in the art. Thus, the architecture of exemplary devices will not be explained in detail, except to note that the devices will generally have a processor, memory (of some kind), and input and output mechanisms. In some cases, the devices may also have one or more operating systems and one or more application programs that are managed by the operating systems. In some embodiments, the hardware devices or software executed by the hardware devices also provides some ability, depending on the role of the device in the particular embodiment of the invention implemented, to encrypt data or decrypt encrypted data. A decryption capability may be provided using a decryption hardware or software module capable of decrypting data that is encrypted using a particular encryption algorithm.

Other embodiments of the invention can be implemented in a distributed environment where individual computers, or network peers, can select advertisements and obtain agreements independently. The independent nature of each transaction lends itself to using distributed computing environments to select advertisements, obtain permission to display these advertisements, and serve these advertisements. In environments like these, many computers may perform the same or similar tasks independent of each other without rigorous coordination from a centralized server.

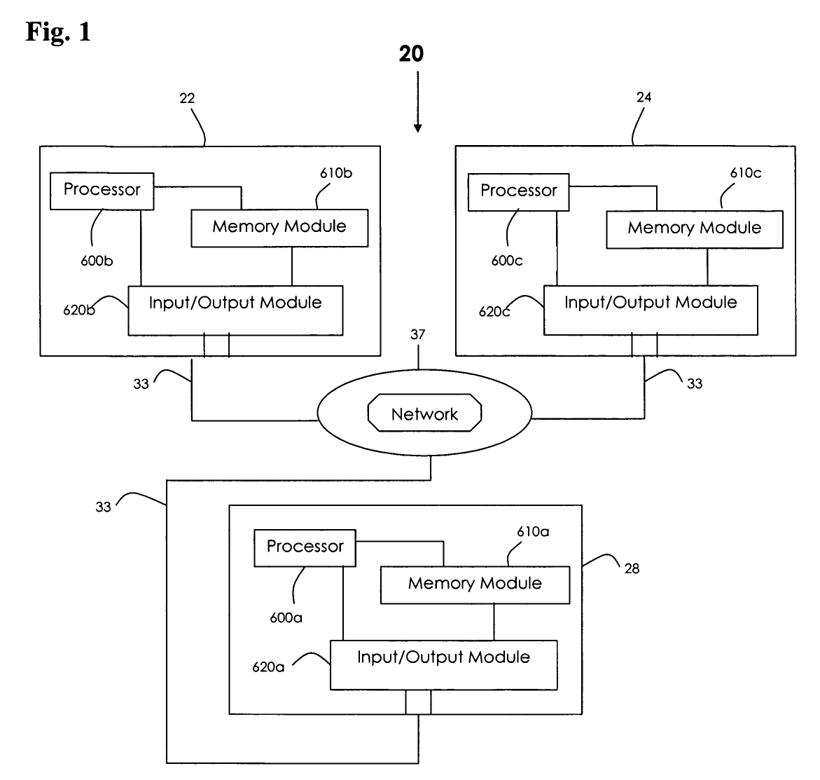

FIG. 1 is a schematic view of the system 20, which is configured to discern the intent of the user of a user device 28 who requests additional information, such as an HTML encoded web page, about an advertiser by, for example, selecting or clicking (using a mouse of other user input device) on the advertiser's linked advertisement. In reality, one or more networks or communication systems, such as a private network (i.e., an intranet), the Internet, the telephone system, wireless networks, satellite networks, cable TV networks, and various other private and public networks and systems, could be used in various combinations to provide the communication links desired or needed to create embodiments or implementations of the invention, as would be apparent to one of ordinary skill in the art. Thus, the invention is not limited to any specific network or combinations of networks. Data can be transferred from one entity to another with wired communications and/or wireless communications or other physical media being carried from one entity to another.

Further, while the exemplary embodiments herein are presented with reference to content comprising advertisements, the disclosed methods and systems can also be employed to track and document users' selections of other types of content, including but not limited to news, weather, entertainment, games, mapping, music downloads, video downloads, and other types of content.

As shown in FIG. 1, the system 20 includes a user device 28, a content server 22 (which stores linked advertisements and optionally, other content), and an advertiser server 24 (that stores an advertiser's web content). In other embodiments of the invention, the system 20 may include fewer or additional devices, by for example, combining the content server 22 and the advertiser server 24 on the same device. Each device includes a processor 600 (e.g., 600a, 600b, and 600c), a memory module 610 (e.g., 610a, 610b, and 610c), and an input/output module 620 (e.g., 620a, 620b, and 620c). It should be understood that the components shown in FIG. 1 are exemplary and can be combined and distributed in various arrangements and configurations. For example, a memory module 610 can be included in a processor 600 and/or an input/output module 620 in place of or in addition to being included as a separate component. The input/output modules 610 can also be located in an apparatus external to the device housing the corresponding processor 600.

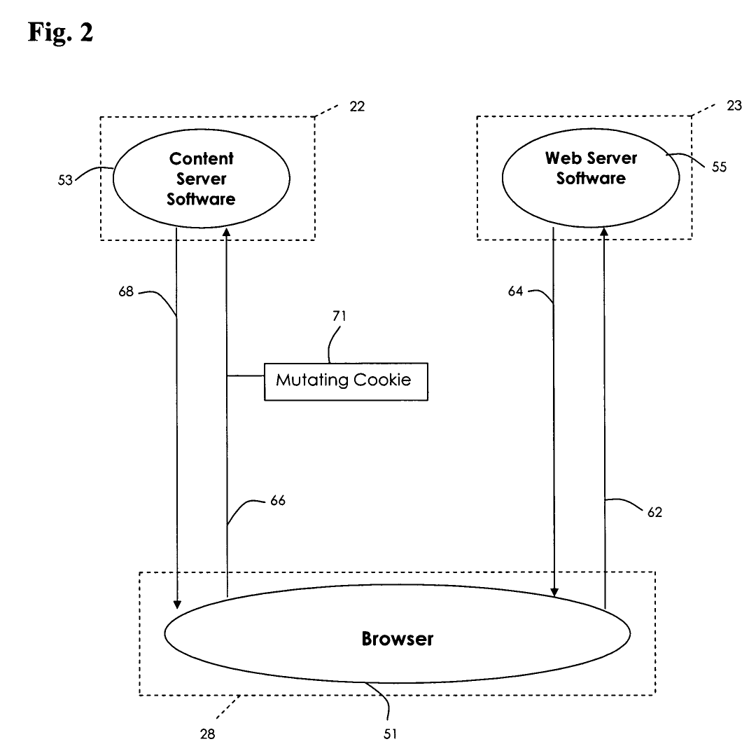

The processor 600 can include one or more processors or similar circuitry. The memory modules 610 store instructions and data retrieved and executed by the processor 600. The functions performed by each processor 600, and consequently the instructions and data stored in the memory module 610 of each device, can be configured based on the role a particular device plays in performing a transaction. In one embodiment, the user device 28 is configured to run some sort of user agent or software that permits a user to access information, such as a browser 51, capable of communicating with other devices configured to run an HTTP server over a computer network, as described below and illustrated in FIG. 2. In this embodiment, the processor 600a on the user device 28 is capable of executing the functions performed by the browser 51 and the memory module 610a stores the instructions and data used by the processor 600a. In addition, the content server 22 and the advertiser server 24 are both configured to run HTTP servers, capable of receiving and responding to requests from a device configured to run an HTTP client, such as a browser 51, over a computer network, as described below and illustrated in FIG. 2. In this embodiment, the processors 600b, 600c on the content server 22 and the advertiser server 24 are capable of executing the functions performed by an HTTP server and the memory modules 610b, 610c store the instructions and data used by the processors 600b, 600c. It should be noted however that the invention may also be used with other computer applications and computer network protocols such as UDP or TCP/IP. In addition,

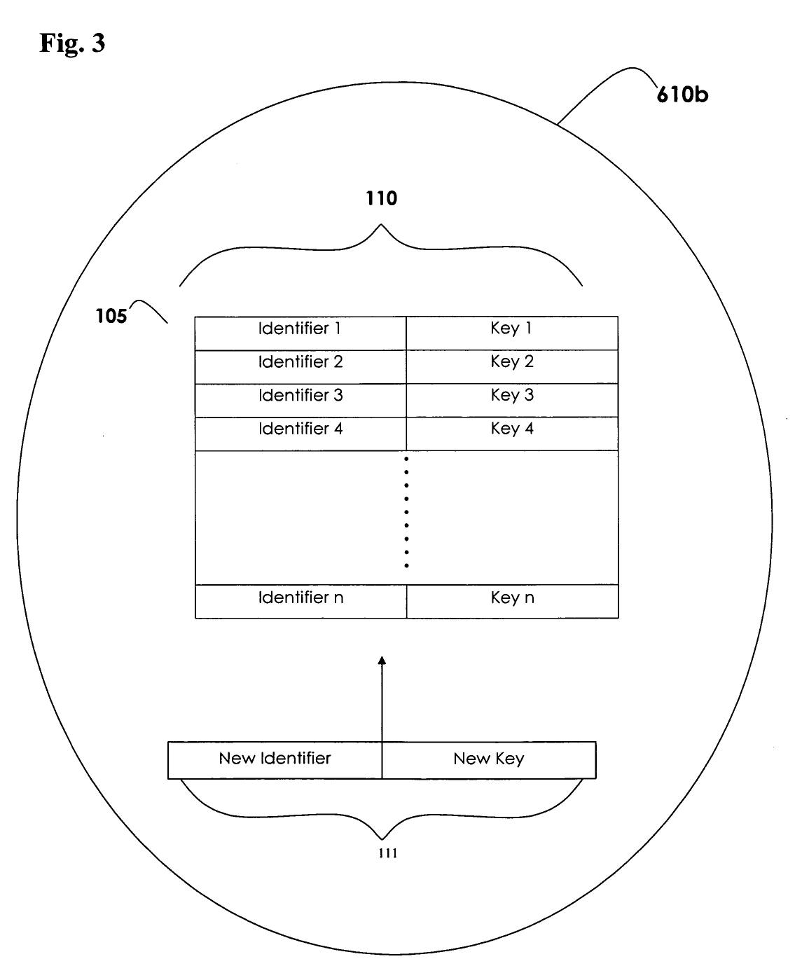

In addition to storing the instructions and data used by the processors 600, the memory modules 610 can also store data received or transmitted by a particular device via its input/output module 620. For example, in one embodiment the memory module 610a stores at least one HTTP cookie which is associated with the content server 22 and which contains encrypted data concerning the history of interactions between the user device 28 and the content server 22, and an unencrypted identifier. The encrypted data concerning the history of interactions can be analyzed to produce the various Metrics, as discussed below. Further, the memory modules 610b, 610c for the content server 22 and advertiser server 24 may store at least one identifier/key pair used by the processors 600b, 600c to encrypt and decrypt data as described below with respect to FIGS. 2 and 3.

As shown in FIG. 1, each device includes an input/output module 620 that interfaces with at least one communication link 33. It should be understood that although the devices as shown are connected to each other by a single, direct connection, the devices may be connected via one or more wired or wireless connections over one or more networks 37 or communication systems. Each input/output module 620 can also interface with additional devices over the same or additional communication links.

As directed by a processor 600, each input/output module 620 can output data to another device. Similarly, each input/output module 620 can receive data from another device and forward the data to the associated processor 600 and/or memory module 610. As noted above, the input/output module 620 of a particular apparatus can be located external to the apparatus housing the processor 600 and/or the memory module 610.

In general, the content server software 53 generates data that will be used in the evaluation of the transactional history of a browser 51 to determine whether to display an ad on the browser 51. The evaluation is based on one or more sources of information, including information stored on the user device 28 associated with the browser 51, for example in the form of a cookie. The content server 22 may also include storage space to track additional information associated with each cookie, since the cookies are limited in how much information they can contain.

The content server software 53 can also include functions that allow the advertisers to set or change parameters such as those discussed herein, for example to set the numerical or other values associated with the metrics discussed below. In one embodiment the functions are implemented on the content server 22 through a web interface accessible from the advertiser's browser. In one embodiment the advertiser accesses the web interface through a secure connection, e.g. using a PKI certificate. The functions may be integrated into the content server software 53, or may be a separate software component on the content server 22, or the functions may be stored and executed from a different hardware platform altogether.

In one embodiment, the advertiser maintains its own independent proxy server that includes the various metrics and tools and uses these to evaluate whether to agree to display an ad on a particular browser. The advertiser's proxy server or the content server 22 may include a log of information representing a compilation of ad clicking history obtained from the various browsers' cookies. The metrics and tools on the proxy server can use the information in the log when evaluating whether to accept placement of an ad on the browser.

Generally, the cookies that are associated with a browser are so-called “persistent cookies” which include an expiration date. The cookie expiration date can be set for any length of time into the future, for example any number of minutes, hours, days, weeks, months, years, etc. from the date the cookie is created or last modified. Without an expiration date the cookies are typically deleted by the operating system or browser as soon as the browser program is closed.

Thus, in one embodiment the advertiser maintains its own server that manages the metrics and other protocols that are used to predict whether to place an on a particular browser. The content server software 53 delivers to the advertiser's server any information needed to perform the protocols, including for example the recent ad presentation and ad clicking activity of the browser in question. In one particular embodiment in which the advertiser maintains its own server, the advertiser's server can communicate with the content server 22 through the network 37, so that the advertiser's server can give approval for placing each ad. To prevent the content server 22 from having to wait too long for a response from the advertiser's server regarding whether to run the ad, a timeout duration can be set, e.g. 100 milliseconds. If the content server 22 does not receive a response from the advertiser's server regarding whether to run a particular ad before the timeout period expires, then the content server 22 will run a different ad on the browser 51.

In other embodiments, the metrics and other protocols are run on the content server 22 but are effectively under the control of the advertiser via a web-based settings menu that is run from the content server 22. In either case, the advertiser maintains control over which of its ads are placed on browsers, albeit indirectly by setting parameters. Further, in various embodiments the metrics and other protocols can be applied to all of the ads for a particular advertiser, some subgroup of ads, or each ad individually. Finally, by separately tracking which ad has been shown to which browser, it is possible for an advertiser to present groups of ads to a browser in a sequential manner to effect a graded ad campaign or to “tell a story” through the presentation of ads in a particular sequence.

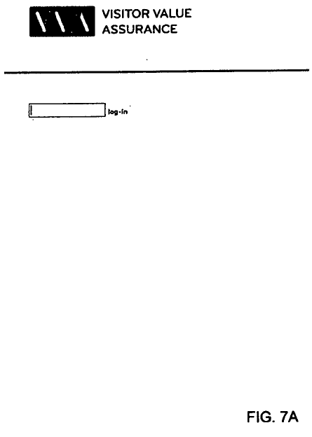

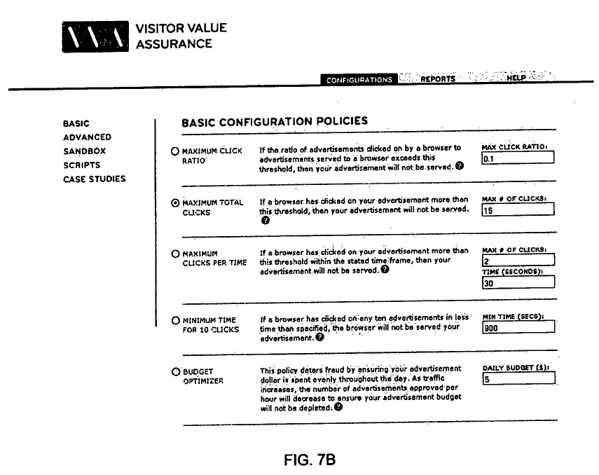

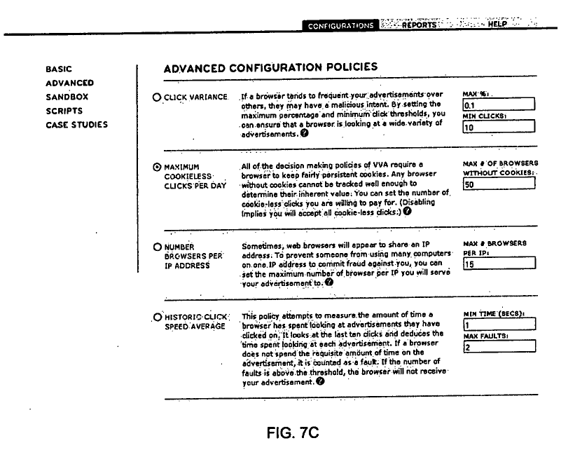

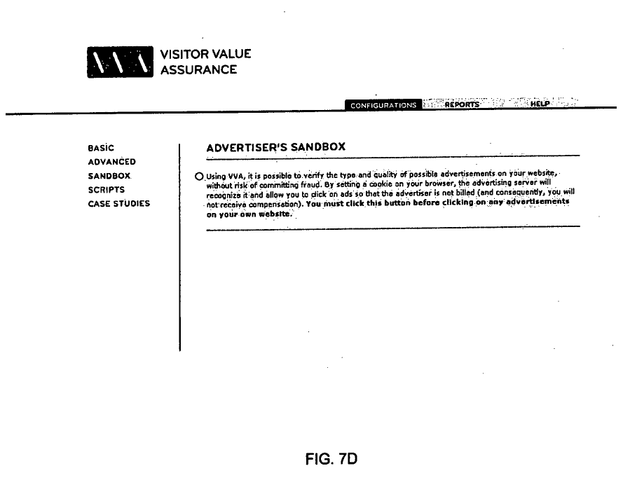

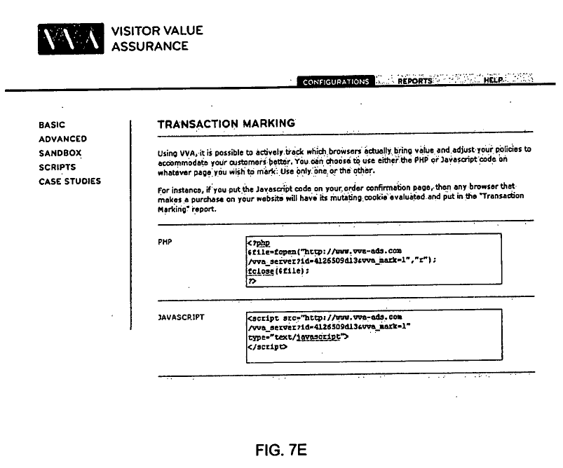

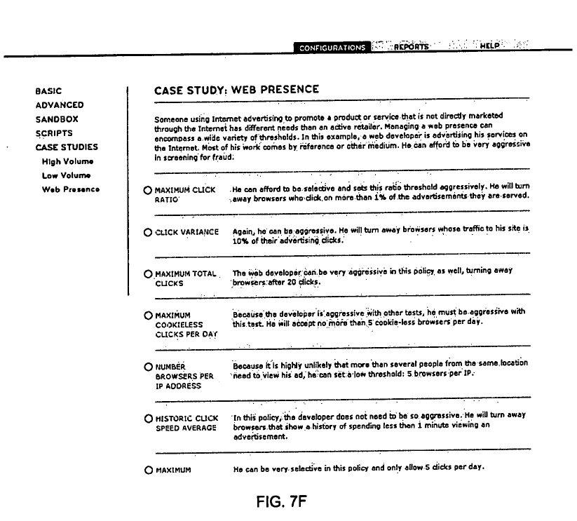

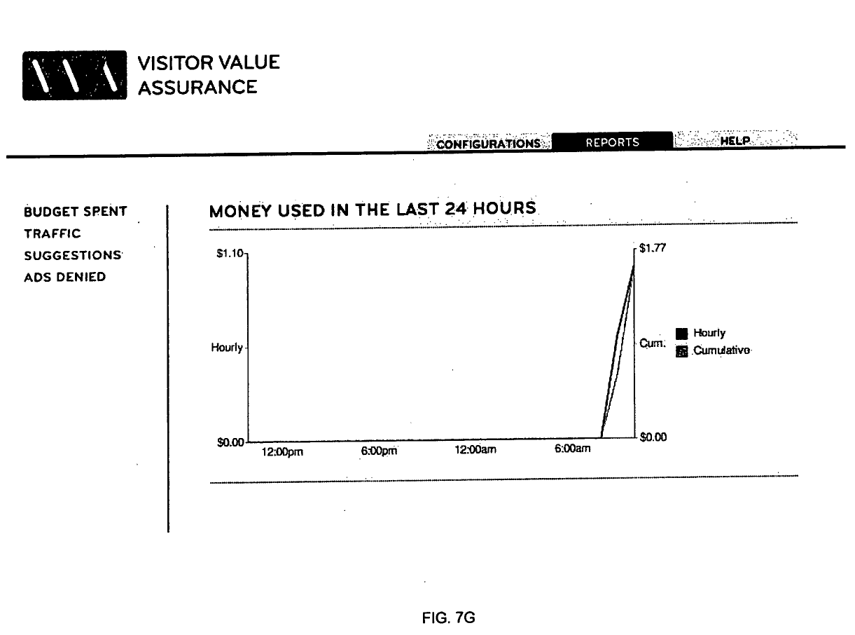

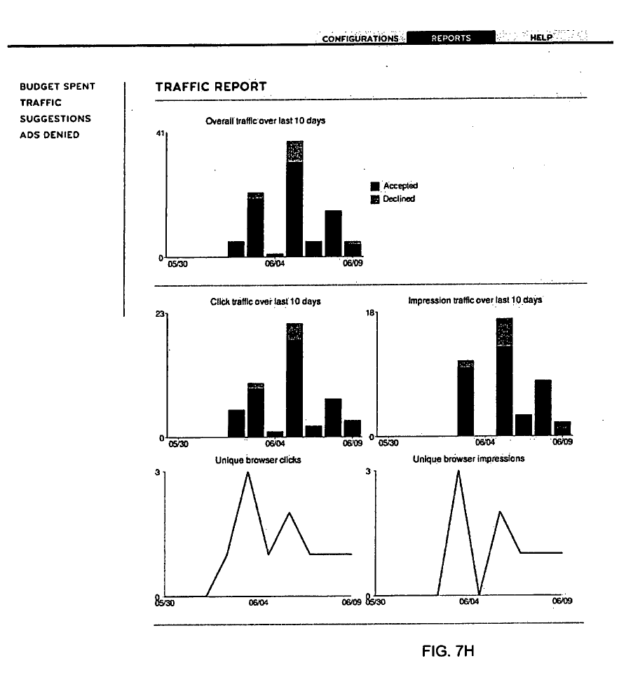

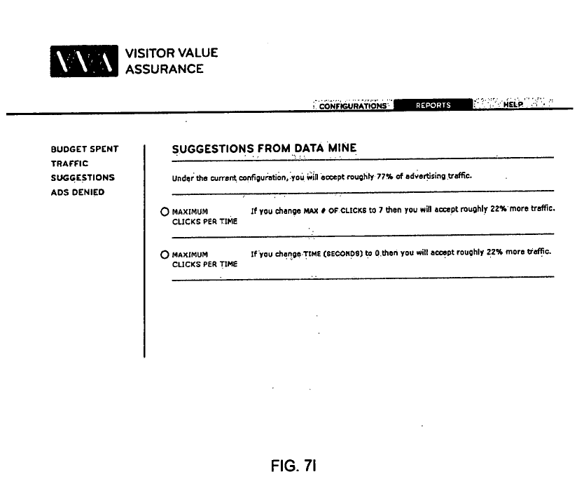

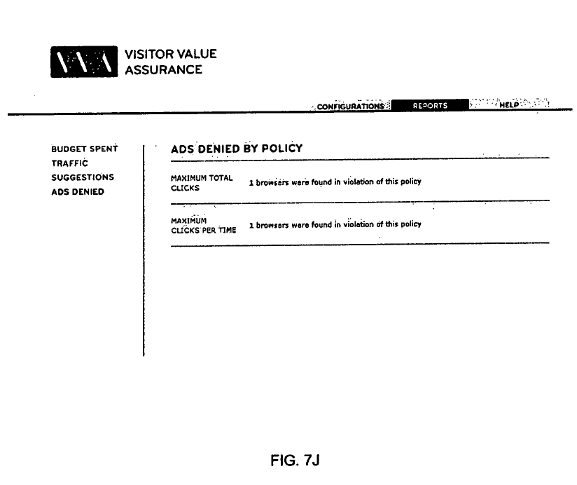

Examples of an embodiment of a web interface for an advertiser to set parameters for the metrics and other protocols are shown in FIGS. 7A-7J. As discussed, the web interface may be operated from the content server software 53 running on the content server 22 or from a different location such as the advertiser's proxy server. In one embodiment, the web interface is implemented as a graphical user interface, e.g. using HTML or other commands to generate and send appropriate web pages, or windows, from a server to a browser for display.

FIG. 7A shows an example of a web page for logging in to the web interface. FIG. 7B shows a Basic Configuration Policies menu page on the web interface. The Basic Configuration Policies menu page allows the advertiser to set parameters related to the metrics and other utilities by entering information in blanks and to turn on and off the metrics and utilities by clicking buttons, e.g. displayed as radio-type buttons. Entering information into the blanks sets various parameters related to the metrics and utilities. Clicking the various radio buttons into the on or off position instructs the proxy server, content server 22, or other computer whether to evaluate the metric or utility with each iteration of the Ad Presentation Protocol and/or the Ad Click Protocol. Among the Basic Configuration Policies that can be turned on or off and whose values can be adjusted are the Maximum Click Ratio, the Maximum Total Clicks, Maximum Clicks Per Time, Minimum Time for 10 Clicks, and the Budget Optimizer.

FIG. 7C shows an Advanced Configuration Policies Page. The metrics and/or utilities included in one embodiment of this page include Click Variance, Maximum Cookieless Clicks Per Day, Number Browsers Per IP Address, and Historic Click Speed Average.

FIG. 7D shows an Advertiser's Sandbox page, which allows an advertiser to turn on and turn off the Sandbox Mode (see below).

FIG. 7E shows a Transaction Marking page. This page presents examples of Java or PHP scripts that an advertiser can add to its web pages to track purchases or other visits to the advertiser's web site by customers and to log such activity for further analysis, e.g. to determine whether such site-visiting activity is related to previous ad displays. The scripts that are presented can be copied from the display boxes and pasted or otherwise transcribed into a script in a page on the advertiser's web site. Other scripting languages can also be presented.

FIG. 7F shows a Case Study page. The Case Study page presents different sets of configurations of the metrics and utilities for different types of web advertisers, e.g. for High Volume web retailers, Low Volume web retailers, and retailers who simply want to maintain a limited Web Presence.

FIG. 7G shows a Report of Budget Spent, specifically Money Used in the Last 24 Hours. A graph is presented which shows the consumption of an advertiser's budget as a function of time, both on an hourly basis and as a cumulative total.

FIG. 7H shows a Traffic Report, showing the number of ad displays (impressions) and/or ad clicks as a function of time. In the embodiment shown in FIG. 7H, the data is presented in daily increments. Bar graphs are presented which show the number of ads that were accepted, i.e. sent to a browser for display, and the number declined, i.e. the number of times an ad was not displayed because the browser failed to meet the criteria defined by one or more of the metrics or utilities. Bar graphs are shown for Overall Traffic Over the Last 10 Days, Click Traffic Over the Last 10 Days, and Impression Traffic Over the Last 10 Days. In addition, line graphs are shown which depict Unique Browser Clicks and Unique Browser Impressions. Unique browser clicks and impressions refers to impressions and/or clicks generated by separate browsers, rather than repeated impressions or clicks generated from the same browser.

FIG. 7I shows a Suggestions from Data Mine page. This page allows the advertiser to adjust the parameters related to the various metrics and utilities, whereupon the system 20 analyzes data from ads that were presented or denied to determine what effect the changes in parameters would have on the number of ads served or ad clicks likely to be generated.

FIG. 7J shows an Ads Denied page. This page shows a report of the number of times the system 20 failed to deliver an ad (i.e. denied the ad) to a browser 51 due to the limitations set in the various metrics and utilities. In one embodiment, the number of ad denials is listed separately for each metric or utility that led to the denials, and in other embodiments a single aggregate number of denials is shown.

Each page or field within a page may have a Help Button (e.g. shown as a “?”) associated therewith to explain how the page, metric, or utility works. The particular features shown in the web interface can be arranged and grouped in many other configurations besides those shown in the exemplary embodiments of FIGS. 7A-7J. Moving between pages of the web interface can be facilitated by means such as tabs along the top of the page and/or other clickable text or images, among other mechanisms for navigating the pages.

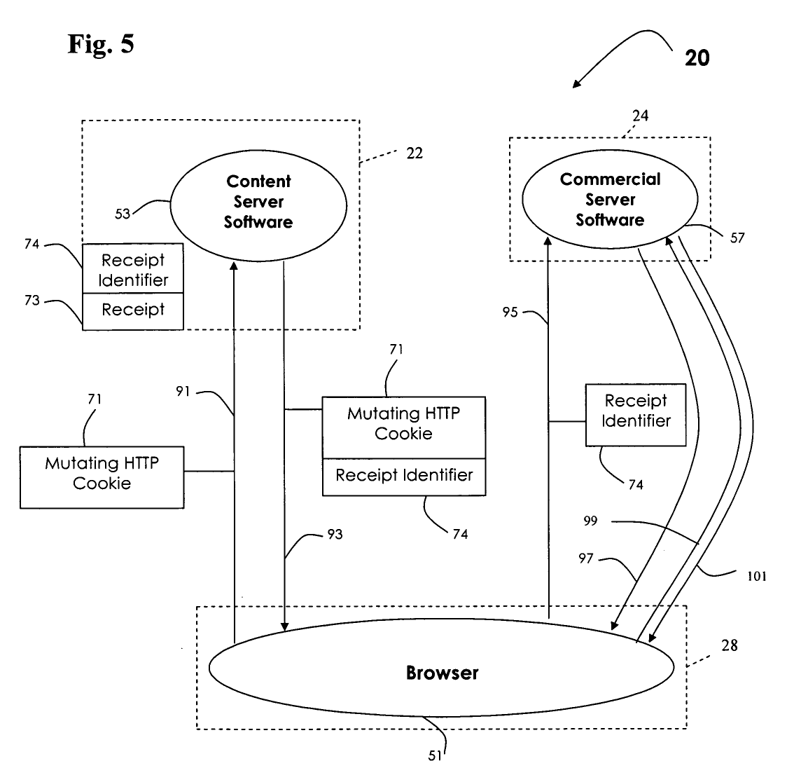

The system 20 utilizes two protocols: an Ad Presentation Protocol and an Ad Click Protocol. These protocols, which are described below, are used to gather information which can then be analyzed to infer the intent of a user who clicks on a linked advertisement. As shown in FIGS. 2 and 5 and described in greater detail below, the Ad Presentation Protocol and the Ad Click Protocol are implemented by a browser (B) 51, content server software (S) 53, web server software (C) 55 (FIG. 2), and commercial server software (A) 57 (FIG. 5). The following table, Table 1, is a list of other symbols used in this document to explain the illustrated embodiments of the proposed protocols.

TABLE 1

| Symbol | Meaning |
|---|---|
| P | Data (e.g., information regarding or summarizing the history |
| | of interactions between two devices). |
| K_{X} | A key for a symmetric cipher. |
| N_{X} | A one-use identifier associated with some key K_{X}. |
| E(K_{X}, W) | A cipher E that encrypts W with a key K_{X}. |
| X → Y:Z | A message Z sent from X to Y. |
| CK(X) | Information X which has been placed inside of an HTTP |
| | cookie CK. |

### Ad Presentation Protocol

FIG. 2 is a schematic representation of the Ad Presentation Protocol. In one embodiment, the Ad Presentation Protocol is implemented by a browser 51; content server software 53, which resides on the content server 22; and web server software 55, which may reside on a Third-Party Web Server 23. The Ad Presentation Protocol is implemented by the system 20 each time that the browser 51 transmits a request 62 to the web server software 55. In the illustrated embodiment, the Ad Presentation Protocol consists of four steps as shown in Table 2 and described in detail below:

TABLE 2

| | | |
|---|---|---|
| 1. | B → C | The browser 51 requests information, such as an encoded web page, from the |
| | | web server software 55. |
| 2. | C → B | The web server software 55 transmits the requested information, for example an |
| | | encoded web page, to the browser 51. Within the encoded web page are |
| | | instructions to tell the browser 51 to retrieve linked advertisements from the |
| | | content server software 53. |
| 3. | B → S | The browser 51 sends a request to the content server software 53. This request |
| | | includes the fact that the browser 51 requested a document from the web server |
| | | software 55 and may include other information, including encrypted data with |
| | | information regarding the browser's 51 past advertisement clicking behavior. |
| 4. | S → B | The content server software 53 parses this information and returns appropriate |
| | | ads and other information, including updated encrypted data regarding the |
| | | browser's 51 past advertisement clicking behavior. |

According to this embodiment of the invention, the first step of the Ad Presentation Protocol is initiated when the browser 51, in response to the actions of the user, transmits a request (Req₆₂) 62 to the web server software 55, requesting information, such as an encoded web page, as described above and depicted in FIG. 2.

B→C: Req₆₂

During the second step of the protocol, the web server software 55 transmits a response (Resp₆₄) 64 to the browser 51 containing the requested information, such as an encoded web page. It should be understood that the web page may be encoded using HTML, XML, XHTML, or any other language or protocol suitable for encoding information on the Internet. Within the encoded web page are instructions that tell the browser 51 to request linked advertisements from the content server 22. In one embodiment of the invention, these linked advertisements are interactive in nature such that a user can select them, using a mouse or other user input device, to view web content of an advertiser.

C→B: Resp₆₄

During the third step of the Ad Presentation Protocol, the browser 51 sends a request (Req₆₆) 66 to the content server software 53. This request notifies the content server software 53 that the browser 51 requested a web page from the web server software 55 and may include other information stored in cookies which are associated with the content server software 53. The first stage of this third step of the Ad Presentation Protocol is carried out in two ways, depending on whether the user device 28 has encrypted data, containing information about the prior interactions between the browser 51 and the content server software 53, and an unencrypted identifier stored on its memory module 610a. Both the encrypted data and the unencrypted identifier are discussed in detail below.

If the user device 28 does not have the encrypted data and the unencrypted identifier stored in its memory module 610a, then the browser 51 transmits only the request 66 to the content server software 53.

B→S: Req₆₆

The content server software 53 parses the information transmitted by the browser 51 as part of the request 66, including any cookies transmitted by the browser 51. The content server software 53 generates new data (P_{new}) containing information regarding the current interaction between the browser 51 and the content server software 53. Some examples of the types of information contained in this new data are discussed below. The content server software 53 also generates an identifier (N_{new}) and a key (K_{new}) and uses a symmetric encryption algorithm (E) to encrypt the new data using K_{new} as a key (E(K_{new}, P_{new})).

The content server software 53 stores the identifier/key pair (K_{New}/N_{New}) on the memory module 610b of the content server 22. As shown in FIG. 3, in one embodiment of the invention, the identifier/key pairs (Nx/Kx) 110 that are generated by the content server software 53 may be stored in a lookup table 105. The lookup table 105 stores a number of identifier/key pairs 110 and is configured such that any key Kx may be located in the table by using the corresponding identifier Nx. In other embodiments, these identifier/key pairs may be stored in a data structure that enables the content server software 53 to quickly locate a key Kx which corresponds to a given identifier Nx.

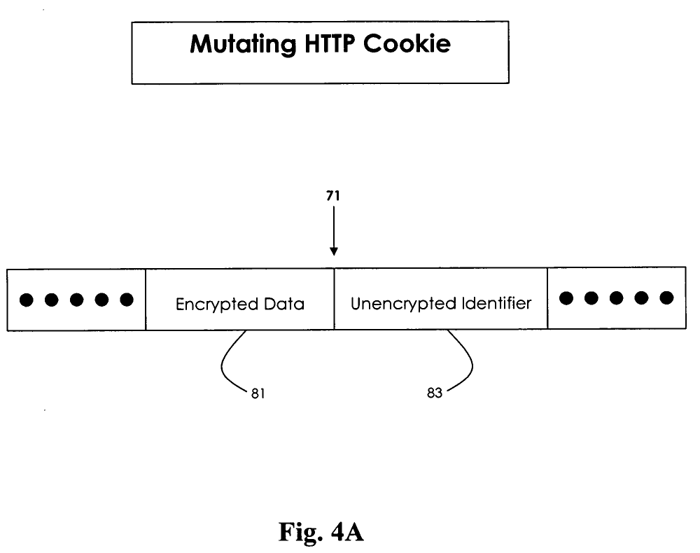

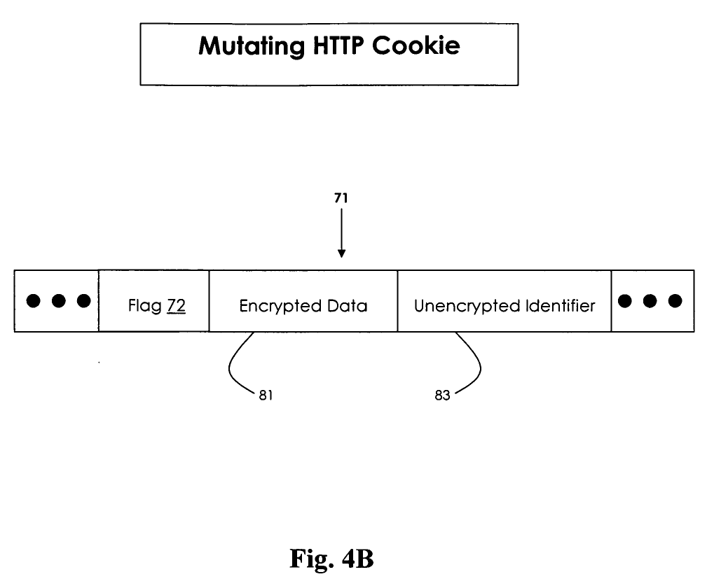

Alternatively, if the user device 28 has encrypted data (E(K_{old}, P_{old})), containing information about previous interactions between the browser 51 and the content server software 53, and an unencrypted identifier (N_{old}) stored in its memory module 610a when the browser 51 sends the request 66, the browser 61 sends both of these items along with the request 66. In one embodiment, the encrypted data and the unencrypted identifier are stored in the form of a mutating cookie 71. FIGS. 4A and 4B are representations of two possible types of mutating cookies 71. The mutating cookie 71 includes encrypted data 81 and an unencrypted identifier 83. In this embodiment, the mutating cookie 71 is transmitted with the request 66.

B→S: Req₆₆,CK(N_{old},E(K_{old},P_{old}))

The content server software 53 parses the request 66 and the mutating cookie 71. The content server software 53 extracts the unencrypted identifier 83 from the mutating cookie 71 and uses it to locate a key (K_{old}) stored in the lookup table 105. The content server software 53 extracts the encrypted data 81 from the mutating cookie 71 and decrypts the data 81 using the key. The content server software 53 generates updated data (P_{new}) containing information about this interaction and previous interactions between the browser 51 and the content server software 53 in the manner described below. In addition, the content server software 53 generates a new identifier/key pair (N_{new}/K_{new}) and uses the new key to encrypt the updated data (E(K_{new}, P_{new})). The new identifier/key pair 111 is stored in the lookup table 105 and the old identifier/key (K_{old}/N_{old}) is deleted from the lookup table or marked as used, so that each identifier and key are only used one time.

The mutating cookie 71 may contain a number of different fields pertaining to the state information of the browser. Included among the possible fields in the mutating cookie 71 are: a unique identifier for the browser 51; the time of day that the mutating cookie 71 was placed on the browser 51 (or the time the mutating cookie 71 was sent to the browser 51); the time that the browser 51 spent viewing one or more ads; the respective times of the browser's 51 last ten ad clicks; the respective times of the last ten ad loads onto the browser 51; the Internet Protocol (IP) address of the browser 51; information describing a plurality of previous clicks (e.g. the previous thirty-two clicks), such as the domain, the URL, a context or keyword, and the time of day of each click; an indicator of whether or not the browser is in Sandbox Mode (using flag 72, discussed further below) and may also include the address of the web site that is in Sandbox Mode; the address of the referring site, i.e. the site the ad will be placed on; the price for placing a selected ad; and the price for clicking on the selected ad. Some or all of the information stored in the mutating cookie 71 may be stored as hash values, or hashes, produced from the text. In one embodiment, a mutating cookie 71 that includes at least one of the above fields is referred to as a receipt 73 (discussed further below).

During the final stage of this third step in the Ad Presentation Protocol, the content server software 53 generates a new mutating cookie 71 which contains the new or updated encrypted data and, in some embodiments, the unencrypted new identifier. The content server software 53 also selects the advertisement to be linked and displayed on the web page that the user is viewing. The selection of the advertisement to be displayed may depend on the subject matter of the web page where the advertisement will be viewed and/or on one or more characteristics of the browser 51. Depending on these characteristics, the content server software 53 will select advertisements that increase its revenues and decrease the risk of malicious advertisement clicking behavior. For example, the content server software 53 may determine that the browser 51 is likely to be of malicious intent by using one or more of the metrics described below. If the browser 51 is likely to be of malicious intent then the content server software 53 can select an alternative advertisement that is less vulnerable to the behavior. Alternatively, the content server software 53 may deliver the advertisement to the browser 51 but not charge the advertiser for the display or subsequent click on the ad, if any. Thus, no indication is generally given to the user of the browser 51 that it has been identified as suspicious. This impedes the ability of the malicious user to easily learn the types of behavior and the thresholds that the content server software 53 is using to identify suspicious behavior, and adjust its behavior accordingly. Preferably, the choice of alternative advertisement is one that is consistent with the type of advertisement that would be expected on the web page.

The content server software 53 transmits a response 68 to the browser 51 containing the encoded linked advertisement that will be displayed on the web page that the user is viewing. In addition, the content server software 53 transmits the new mutating cookie 71 to the browser 51 along with the response 68.

S→B: Resp₆₈,CK(N_{new},E(K_{new},P_{new}))

The browser 51 receives the response 68, stores any HTTP cookies sent as part of the response 58, including the mutating cookie 71, in the memory module 610a of the user device, and displays the linked advertisement on the web page.

It should be understood with respect to the Ad Presentation Protocol that in alternative embodiments, non-mutating cookies may be used. That is, the content server software 53 may reuse the same identifiers or even the same keys when encrypting the updated data, such that it is unnecessary to generate a new identifier and/or new key for each instance of the Ad Presentation Protocol. Further, additional embodiments may not require the creation and use of any identifiers by the content server software 53. In such an embodiment, when the content server software 53 receives encrypted data from a browser 51, it will try to decrypt it using one of the keys stored in the memory module 610b of the content server 22. The content server software 53 may attempt to decrypt the encrypted data using the key that was stored in the content server's 22 memory module 610b most recently. If that key successfully decrypts the encrypted data, then the decryption process ends. If the key is not successful, then the content server software 53 may attempt a number of the other keys that were most recently stored in the memory module 610b of the content server 22. If any one of those keys successfully decrypts the encrypted data, then the decryption process ends. If none of those keys is successful, which may indicate that the encrypted data is old and no longer relevant, then the decryption process is unsuccessful and the encrypted data is discarded.

In still other embodiments, the system 20 may maintain a counter whose value is returned to the browser 51 at the end of each transaction. The counter value sent to each browser may be stored in a number of locations, for example on the content server 22, on the advertiser's proxy server, or any other suitable location. The counter value may be incremented each time a new ad is served or the counter value may simply be a random number. When a request for an ad is received from a browser 51, the value of the counter that is included with the request is compared to at least one of the counter value that was previously received from the same browser 51 and the counter value that was previously sent to the browser 51. If the counter value received from the browser 51 is the same for two requests, it indicates that the second request is not ‘fresh,’ which may indicate that the browser 51 is re-sending the same information with the request, possibly in an effort to avoid detection of its ad-viewing or ad-clicking activity. Similarly, if the counter value that is received along with the request from the browser 51 is not the same as the value that was most recently sent to the browser 51 as part of the previous transaction, this may also indicate that the browser 51 is sending incorrect information along with the request, possibly to avoid detection of its activities. The counter value may be exchanged between the browser 51 and a server using a cookie, or alternatively using an HTML GET or POST command.

Although many exemplary embodiments presented herein utilize encrypted information in the cookies, in other embodiments the inventive methods can be performed without encryption. In one embodiment, each cookie is a random number, which is chosen by a server such as the content server or proxy server and which changes with each advertisement load and/or click. This random number can serve as an index into a database stored at the advertiser's proxy server or other server, where the database stores the past browsing habits of the browser 51. In one particular embodiment, when presented with the random number, the server looks up the browsing habits in the database, updates the information pertaining to the browsing habits, sends the browsing habits information to the proxy server, and awaits the response. In some embodiments, once the random number has been used once, it is marked as such or deleted.

In an alternative embodiment, a “fresh” (i.e. not previously used) and unpredictable identifier is included with client requests and server responses to refer to state information held by the server. The following approach requires 2n storage where n is the size of non-stale “clients”. This approach has the advantage that no keys (or cryptography) are used and hence there is no need to account for keys that “expire”. Also, this approach has the property that it is tolerant to a threshold of failures while maintaining historical information (i.e. due to a communication failure need not start from scratch and treat a client as a new entity). This technique for tolerating a threshold of failures can be extended to other methods. Upon receipt of a request with an invalid (or non-existent) state information, assign the “new” browser a number Cᵢ. Preferably, the number Cᵢ is a random number chosen from a large space so that it is highly unlikely an adversary able to predict a valid Cᵢ. Preferably, the computer has a hardware random number generator for generating random numbers. Alternatively, lists of random numbers can be supplied to the server. The server sends back Rⱼ (and optionally Cᵢ if the browser is unable to maintain Cᵢ for the next request) where Rⱼ is the current “state” associated with the browser. The server stores (Cᵢ, Rⱼ, Null, Counter=0). Upon receipt of (Cᵢ, Rⱼ) the server sends back (Cᵢ, Rⱼ₊₁) and updates the state (Cᵢ, Rⱼ, Rⱼ₊₁, Counter=0}. Computers or communications might fail. Thus, the server associates a counter, “Counter”, with each client. The counter indicates the number of times a request has been received using the immediately prior state Rⱼ. Preferably, the server allows at most one replay of Rⱼ. As an optional extension, the server maintains a window counter, e.g. which might be called “Window_Counter”, which tracks the number of times replayed state has been received for Cᵢ over some window of time e.g. one month. If the window counter exceeds a threshold then the server operates according to the defined policy. A number of policies can be defined. One policy is to act substantially the same as if the threshold was not exceeded with the exception of changing the payment associated with the click through. The change of payment can be performed in several ways. At the billing cycle the advertiser can be provided with a credit for some number of clicks without being told exactly which requests were associated with the credit. Alternatively, at any point in time one or more parties to the transaction can be told about the charging for the particular click through. This may expose the detection of the fraudulent click-throughs but provides transparency to the parties in the transaction.

In another alternative embodiment, state information can be tracked without receiving a (plaintext) client identifier. The previous approach can be used without using the index Cᵢ associated with the client. This assumes that the random numbers are sufficiently large that it is highly unlikely that an adversary could guess a random number associated with a current or prior state of a client. Preferably, the computer uses associative memory to correlate the random number with an internal customer index used to retrieve the customer's information.

In still another alternative embodiment, state information can be tracked by encrypting the Cᵢ such that anyone other than the server would be unable to determine the particular Cᵢ in the request or response. For example, the transmission of “Cᵢ” in the first embodiment can be substituted with “q, x_p, E(K_{q}, Cᵢ XOR xₚ) where q identifies which key used by the server to encrypt the client identifier Cᵢ, x_p is a fresh random number for each time Cᵢ is encrypted, and enc( ) is block encryption using the key as the first parameter and data to be encrypted as the second parameter. Servers might employ arbitrarily many keys to encrypt client identifiers. Furthermore, the keys can be updated over time by providing a new key identifier and new encryption in a server response. That is keys can be used to decrypt old state identifiers and new keys used to encrypt new state identifiers. When the encryption keys change and a client request is received, it is preferable to generate a new client identifier (Cᵢ′) and associate the new client identifier with the old state information (i.e. Cᵢ state information).

### Ad Click Protocol

FIG. 5 is a schematic representation of the Ad Click Protocol. In one embodiment, the Ad Click Protocol is implemented by a browser 51, the content server software 53, and commercial server software 57, which resides on the advertiser server 24. The Ad Click Protocol is implemented by the system 20 each time a user of the user device 28 clicks (using a mouse or other user input device) on a linked advertisement. In the illustrated embodiment, the Ad Click Protocol consists of six steps as shown in Table 3 and described below:

TABLE 3

| | | |
|---|---|---|
| 1. | B → S | The user clicks on a linked advertisement which instructs the browser to send a |
| | | request to the content server software. Other information may also be transmitted |
| | | in this message as cookies. In addition, the browser sends the mutating cookie as |
| | | part of this transmission. |
| 2. | S → B | The content server software returns a response to the browser. This response |
| | | includes instructions for the browser, the mutating cookie, and a receipt identifier |
| | | or an encrypted receipt. |
| 3. | B → A | The browser forwards the receipt identifier or the encrypted receipt to the |
| | | commercial server software. |
| 4. | A → B | The commercial server software records the data and transmits a response to the |
| | | browser, forwarding the browser to the appropriate web site. |
| 5. | B → A | The browser transmits a request to a web server (which may be the same as the |
| | | advertiser server), requesting the requested web content. |
| 6. | A → B | The web server transmits the appropriate web site to the browser. |

During the first step of the Ad Click Protocol the user clicks on a linked advertisement (using a mouse or other input device) and the browser 51 transmits a request (Req₉₁) 91 to the content server software 53. The request 91 notifies the content server software 53 that a linked advertisement has been selected on the browser 51, and contains information regarding the linked advertisement that was selected, the referring web site, and additional information, some of which may be stored in HTTP cookies. The request 91 also contains a mutating cookie 71 associated with the content server software 53.

B→S: Req₉₁,H(N_{old},E(K_{old},P_{old}))

The content server software 53 receives the request 91 and parses the information contained therein. The unencrypted identifier (N_{old}) 83 is extracted from the mutating cookie 71 and is used to locate the corresponding key (K_{old}) in the lookup table 105. The encrypted data (E(K_{old}, P_{old})) 81 is extracted from the mutating cookie 71, decrypted using the key, and updated with additional information (P_{new}) regarding the current interaction between the content server software 53 and the browser 51, as described below. The content server software 53 generates a new identifier/key pair (N_{new}/K_{new}) 111, and uses the new key to encrypt the updated data (E(K_{new}, P_{new})). The content server software 53 stores the new identifier/key pair in the lookup table 105 and deletes the old identifier/key pair from the lookup table 105 or marks the pair as used.

In alternative embodiments, the content server software 53 may reuse the same identifiers or even the same keys when encrypting the updated data, such that it is unnecessary to generate a new identifier and/or new key for each instance of the Ad Click Protocol. Further, additional embodiments may not require the creation and use of any identifiers by the content server software 53. In such an embodiment, decryption of the encrypted data may occur in a similar manner to that described above with respect to alternative embodiments of the Ad Presentation Protocol that do not use identifiers.

As part of the Ad Click Protocol, the content server 53 prepares a receipt 73 for the commercial server software 57. This receipt 73 contains information (P_{rec}) that the commercial server software 57 or the content server software 53 can use to determine the legitimacy of a user click through on its linked advertisements in real-time (or in a time-bounded manner) so that the advertiser can avoid payment of click fees for illegitimate clicks, as described below. In the illustrated embodiment, the receipt 73 includes information that the content server software 53 compiles using the encrypted data in the mutating cookie 71, and, in some embodiments, from data which is stored in the memory module 610b of the content server 22. In addition, the receipt 73 may optionally include a monotonically-increasing number which can be used by the commercial server software 57 to detect repeat receipts. The mutating cookie 71 may include one or more fields documenting the activity of the browser 51, as discussed above.

As depicted in FIG. 5, the content server software 53 generates a unique receipt identifier (ID_{rec}) 74 for the receipt 73 and stores both the receipt 73 and the receipt identifier 74 on the memory module 610b of the content server 22, so that the receipt identifier 74 can be used to retrieve the receipt 73 at a later time. The content server software 53 initiates the second step of the Ad Click Protocol by transmitting a response (Resp₉₃) 93 to the browser 51. The response contains instructions for the browser 51, instructing it to forward the receipt identifier 74 to the commercial server software 57. In addition, the content server software 53 transmits the mutating cookie 71 and the receipt identifier 74 to the browser 51.

S→B: Resp₉₃,H(N_{new},E(K_{new},P_{new})),ID_{rec}

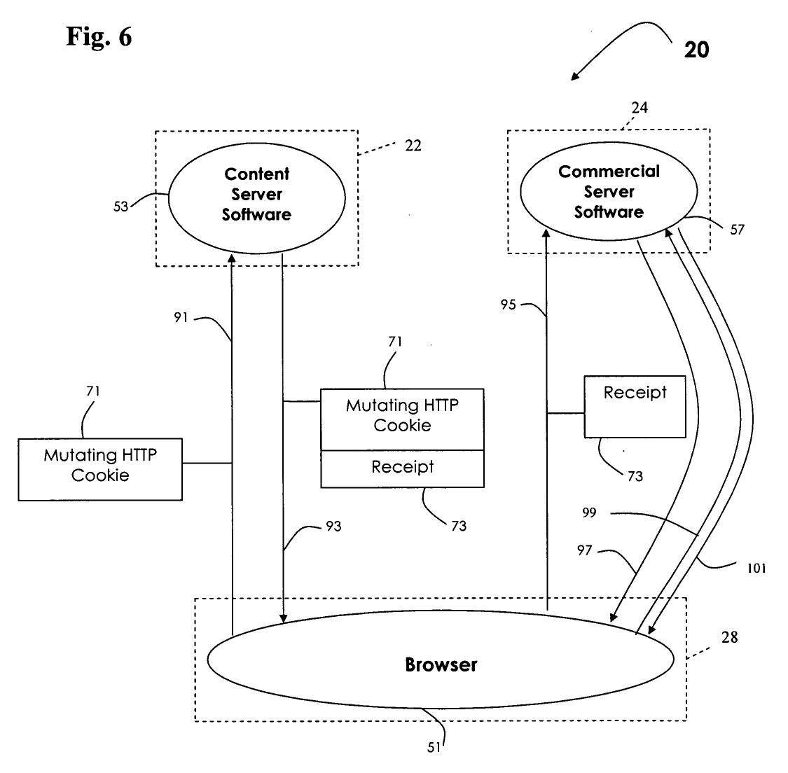

FIG. 6 is a schematic representation of an alternative embodiment the Ad Click Protocol. In the embodiment of FIG. 6, the content server software 53 encrypts the receipt itself and transmits it to the browser 51. In this embodiment, the content server software 53 may share a unique key (K_{rec}) with the commercial server software 57, which is periodically changed. The content server software 53 uses a symmetric encryption algorithm (E) and the unique key to encrypt the receipt (E(K_{rec}, P_{rec})). Alternatively, for each advertiser the content server software 53 may maintain a list of identifier/key pairs in its memory module 610b. The content server software 53 may select an identifier/key pair (N_{rec}/K_{rec}) from an appropriate list and use the key to encrypt the receipt (E(K_{rec}, P_{rec})). In one embodiment, the content server software 53 deletes the selected identifier/key pair from the list after the key is used to encrypt the receipt, such that each identifier/key pair is only used one time. The content server software 53 then implements the second step of the Ad Click Protocol by transmitting the response 93 to the browser 51. This response contains instructions for the browser 51, instructing it to forward the receipt to the commercial server software 57. In addition, the browser 51 transmits the mutating cookie 71 and the encrypted receipt 73.

S→B: Resp₃,CK(N_{new},E(K_{new},P_{new})),E(K_{rec},P_{rec})

If the content server software 53 encrypted the receipt 73 using the key (K_{rec}) from an identifier/key pair (N_{rec}/K_{rec}), the content server software 53 transmits the mutating cookie 71, the encrypted receipt E(K_{rec} P_{rec}) 73, and the unencrypted identifier (N_{rec}) to the browser.

S→B: Resp₉₃,CK(N_{new},E(K_{new},P_{new})),N_{rec},E(K_{rec},P_{rec})

The browser 51 receives the response 93 and parses the information contained therein, including the instructions. The mutating cookie 71 is stored in the memory module 610a of the user device 28.

As shown in FIG. 5, in response to the instructions the browser 51 implements the third step of the Ad Click Protocol by sending a request (Req₉₅) 95 to the commercial server software 57. In addition, the browser 51 transmits the receipt identifier 74 to the commercial server software 57.

B→A: Req₉₅,ID_{rec}

Alternatively, as depicted in FIG. 6, if the content server software 53 transmitted an encrypted receipt as part of the response 93, the browser transmits the encrypted receipt 73 to the commercial server software 57, along with any information that the commercial server software 57 may need to decrypt the receipt (e.g., the identifier which corresponds to the receipt).

B→A: Req₉₅,E(K_{rec},P_{rec}) or B→A: Req₉₅,N,E(K_{rec},P_{rec})

In order to interact with the browser 51 and the content server software 53, the commercial server software 57 must be configured with an application that is capable of receiving, interpreting, and responding to the receipt identifier 74 or the encrypted receipt 73. In one embodiment, this is accomplished through the use of a Common Gateway Interface (“CGI”) application which may be downloaded from the content server 22 and installed on the commercial server 28. This CGI application accepts CGI commands from the browser 51. The use of such an application allows the content server software 53 to send the commercial server software 57 the receipt identifier 74 or receipt 73 and instructions using common HTTP GET or POST protocols. For example, if the domain name for the commercial server software 57 is www.advertiser.com and the browser 51 transmits the receipt identifier 74 as depicted in FIG. 5, then the instructions sent by the content server software 53 to the commercial server software 57, via the browser 51, would be in the following form:
http://www.advertiser.com/cgi-bin/vva?type=incoming&data=ID_{rec}
   Alternatively, as depicted in FIG. 6., the instructions sent by the content server software 53 to the commercial server software 57 could also include the encrypted receipt 73, along with any information that the commercial server software 57 may need to decrypt the encrypted receipt 73 (e.g., an identifier which corresponds to the key used to encrypt the receipt 73), as illustrated in the example instructions below.
http://www.advertiser.com/cgi-bin/vva?type=incoming&data=E(K_{rec},P_{rec})E(P_{rec})
or
http://www.advertiser.com/cgi-bin/vva?type=incoming&data=N_{rec},E(K_{rec},P_{rec})

Referring once again to FIG. 5, upon receiving the request 95 from the browser 51, the commercial server software 57 parses the instructions and extracts the information contained therein and extracts the receipt identifier 74. The receipt identifier 74 is used to access the receipt 73, which is stored in the memory module 610b of the content server 22. In one embodiment, the advertiser can access the receipt 73 by contacting the content server software 53 via a URL which presents a web page where the advertiser can input the receipt identifier 74. The content server software 53 transmits the receipt 73 that corresponds to the receipt identifier 74 to the advertiser in the form of a web page. Authentication of the advertiser may be achieved by requiring that a previously established username and password be provided to the content server software 53 as well. In addition, the content server software 53 may optionally use a secure connection protocol such as Transport Layer Security to ensure that only the authorized parties can view the receipt 73.

In another embodiment, the commercial server software 57 may transmit the receipt identifier 74 to the content server software 53 by causing the advertiser server 28 to establish a separate connection with the content server 22 by sending one or more UDP packets containing the receipt identifier 74 and receiving one or more UDP packets containing the receipt 73, or by creating a TCP/IP connection through a port that is configured to receive receipt identifiers 74 and respond with the corresponding receipt or other communications. The content server software 53 may authenticate these requests for a receipt 73 by checking the IP address of the sender and making sure that it matches the IP address of the proper receipt recipient. In addition, the connection between the advertiser server 28 and the content server 22 may be secured using a technology such as IPSec to ensure that no third parties are able to intercept and view the receipt.

Alternatively, as depicted in FIG. 6., if the content server software 53 transmitted a receipt 73 which was encrypted using a unique key known only by the content server software 53 and the commercial server software 57 as part of the request 95, the commercial server software 57 uses the unique key to decrypt the encrypted receipt 73. On the other hand, if the content server software 53 transmitted a receipt 73 and the identifier which is associated with the key used to encrypt the receipt 73 as part of the request 95, the commercial server software 57 uses the unencrypted identifier to retrieve the key from a list, which is stored on the memory module 610c of the advertising server 28, containing the same identifier/key pairs (N_{rec}/K_{rec}) as the corresponding list which is maintained on the memory module 610b of the content server 22 by the content server software 53. In one embodiment of the invention, this list or the unique key is downloaded from the content server 22 at the same time that the advertiser server 24 downloads the CGI application from the content server 22. The commercial server software 57 uses the key to decrypt the encrypted receipt 73.

Upon obtaining the unencrypted receipt 73, the commercial server software 57 can view and analyze the information contained in the receipt, as described below. If the receipt includes a monotonically increasing number, the commercial server software 57 verifies that it has not received a receipt with the same number previously used to guard against a replay attack.

During the fourth step of the protocol the commercial server software 57 transmits a response (Resp₉₇) 97 to the browser 51. This response contains instructions for the browser 51, instructing the browser 51 to retrieve the web content that should be displayed when the user clicks on the linked advertisement.

A→B: Resp₉₇

In response to these instructions, the browser 51 implements the fifth step of the Ad Click Protocol by transmitting a request (Req₉₉) 99 to a web server (which may be the same as the advertiser server 28) requesting the web content.

B→A: Req₉₉

Finally, web server (which may be the same as the advertiser server 28) responds to the request 99 by transmitting a response (Resp₁₀₁) 101 to the browser 51 containing the appropriate web content.

A→B: Resp₁₀₁

In an alternative embodiment, upon receiving the request 95 the commercial server software 57 immediately transmits the response 97 to the browser 51. The browser 51 then carries out the fifth step of the Ad Click Protocol and the rest of the protocol proceeds as described above. The commercial server software 57 may extract the receipt identifier 74 and retrieve the receipt 73 from the content server software 53 in the manner described previously at the same time that it transmits the response (Resp₉₇) 97 or immediately thereafter. This embodiment reduces the amount of time that the browser 51 must wait before it is able to display the requested web content.

In yet another embodiment, the various methods of validating receipts described above could be implemented in the Ad Presentation Protocol. In step 4, the content server could open a network connection to the advertising proxy server corresponding to advertisements selected for display. Unencrypted receipts could be communicated across this connection and agreements received as in the various Ad Click Protocols detailed above.

The Ad Presentation Protocol, the Ad Click Protocol, and the metrics described below provide information that both the advertiser and the content server software 22 can use to determine whether a browser's 51 advertisement-clicking behavior is legitimate. In some embodiments, it may be beneficial to have the advertiser identify certain constraint thresholds that are indicative of illegitimate browser behavior. The advertiser can specify beforehand that it will not pay for clicks on its advertisements that exceed those thresholds. For example, the advertiser may specify that if a browser 51 spends less than a certain amount of time (e.g., 10 seconds) viewing the advertiser's web content (as determined by the Time Metric Protocol described below) then the advertiser should not be charged for that click. Further, the advertiser may specify that if a browser 51 clicks on its advertisement a disproportionately high number of times in a certain time period (as determined by the Repeat Metric Protocol described below) the advertiser should not be charged for those clicks.

The establishment of these constraint thresholds is beneficial both to the advertiser and to the content server 22. For the advertiser, these thresholds provide some control over how its web content will be viewed and how it will be charged for those viewings. For the content server 22, these constraint thresholds allow it to place advertisements on a web page which will increase its revenues and decrease the number of illegitimate clicks. For example, if the content server 22 recognizes that the advertiser's constraint thresholds are about to be exceeded by the clicking behavior of a particular browser, the content provider may place a different advertiser's link on a web pages that are viewed by that browser 51 to decrease the likelihood of illegitimate clicks. Further, if the content server software 53 recognizes that a particular browser's 51 behavior is particularly malicious, it can place links on the web pages that the browser 51 is viewing without charging the advertiser to avoid revealing to the browser 51 that its malicious behavior has been discovered.

### Time Metric Protocol

Embodiments of the invention are capable of implementing other protocols which are useful in determining the intent of a user who selects a linked advertisement. In one embodiment, the system 20 implements a Time Metric Protocol capable of measuring the amount of time that the advertiser's web content is displayed on the browser 51. This protocol is implemented during a first iteration of the Ad Click Protocol by causing the content server software 53 to record the current time in the updated data 81 that is placed in the new mutating cookie 71, as described above. In addition, when the content server software 53 transmits the response 93 to the browser 51 as part of this first iteration of the Ad Click Protocol, it includes instructions for the browser 51 to transmit a second request 91 to the content sever software 53 after a predetermined amount of time, e.g., ten to thirty seconds.

At the appropriate time, the browser 51 sends the second request 91 to the content server 53, which identifies the browser 51, contains the reason for the request 91, and includes the mutating cookie 71. The content server software 53 implements a second iteration of the Ad Click Protocol. During this second iteration of the Ad Click Protocol, the content server software 53 computes the difference between the current time and the time that was recorded in the encrypted data 81 on the mutating cookie 71 during the first iteration of the Ad Click Protocol. The difference between these two times is placed in the receipt 73 that is generated during this second iteration of the Ad Click Protocol. The protocol proceeds as described above and the receipt 73 is transmitted to the commercial server software 57 in the manner described above.

Upon receiving this receipt 73 from the content server software 53, the commercial server software 57 can determine whether the advertiser's web content was displayed on the user device 28 for at least the predetermined amount of time. This metric allows the advertiser to set a minimum time period that a user should stay on its web site before it will pay for the click and also allows the advertiser to set a maximum number of clicks per day that a user can click on its advertisements. In addition, if the content server software 53 recognizes that a particular browser 51 is not meeting an advertiser's minimum threshold for the amount of time spent viewing its web content, the content server software 53 can choose to place a different advertiser's link on the web pages that the browser 51 is viewing and/or may stop charging for advertisements which are clicked by the browser 51. In some embodiments, an average time per ad view can be determined for ads recently viewed by the browser 51, e.g. for the most recent five, ten, or other number of recently-viewed ads.

### Ratio Metric Protocol

In another embodiment of the invention, the system 20 implements a Ratio Metric Protocol. This protocol allows the advertiser to identify browsers 51 that have an extremely high number of clicks on linked advertisements. This protocol uses two counters: a first counter which is incremented by the content server software 53 for each iteration of the Ad Presentation Protocol and a second counter which is incremented by the content server software 53 for each iteration of the Ad Click Protocol. The counters are maintained in the encrypted data 81 on the mutating cookie 71 and the appropriate counter is updated during each protocol. Thus, the first counter is incremented each time that the content server software 53 updates the encrypted data 81 as part of the Ad Presentation Protocol as discussed above, and the second counter is incremented each time that the content server software 53 updates the encrypted data 81 as part of the Ad Click Protocol, as discussed above. Each of these counters may also be included in the receipt 73 transmitted to the commercial server software 57 during the Ad Click Protocol, as discussed above.

The advertiser and the content server software 53 may utilize these counters to determine whether a user is viewing the advertiser's web content while surfing the web or is merely clicking on linked advertisements with no intent to view the advertiser's web content. A disproportionately high number of Ad Click Protocol iterations with respect to the number of Ad Presentation Protocol iterations for a particular browser 51 indicates that the user of a browser 51 is clicking on an abnormally high number of linked advertisements and that the user's intent may not be to view the advertiser's content. Under such circumstances, the commercial server software 57 may immediately alert the content server software 53 that it has identified suspicious activity. In addition, if the advertiser specified a constraint threshold for the ratio of the number of Ad Click Protocol iterations to the number of Ad Presentation Protocol iterations, the content server software 53 can elect to place a different advertiser's link on the web pages that a browser 51 is viewing and/or to stop charging for the links clicked by the browser 51, when the browser's 51 behavior causes it to near that threshold.

When this Ratio Metric Protocol is combined with the Time Metric Protocol described above, a legitimate linked advertisement click will come from a user of a browser 51 that is primarily surfing the web (i.e., a browser 51 that does not have an abnormally high number of Ad Click Protocol iterations with respect to the number of Ad Presentation Protocol iterations) and who is spending at least a predetermined amount of time on the advertiser's web page as determined by the Time Metric Protocol.

### Refresh Metric Protocol

In certain embodiments the system 20 implements the Refresh Metric Protocol, which may be used to measure the relative activity of a browser 51 and is designed to identify browsers 51 that are attempting to circumvent the Ratio Metric Protocol. The Refresh Metric Protocol requires that two pieces of information be stored in the encrypted data 81 on the mutating cookie 71: a counter which is incremented for each iteration of the Ad Presentation Protocol and the average time between iterations of the Ad Presentation Protocol. The content server 53 updates the encrypted data 81 with this information during each iteration of the Ad Presentation Protocol as discussed above. This information is placed into the information portion of the receipt 73 that is sent to the commercial server software 57 during each iteration of the Ad Click Protocol.

The advertiser and the content server software 53 can compare the average number of iterations of the Ad Presentation Protocol for a particular browser over a particular period of time with the average number of instances of the Ad Presentation Protocol for all browsers that have clicked on the advertiser's links during that time. For example, if the average number of Ad Presentation Protocols run per day for a browser 51 is fifty, with a standard deviation of twenty, then a browser 51 with two hundred or more iterations of the Ad Presentation Protocol would be suspicious. The advertiser can alert the content server 53 should it detect such activity. In addition, if a browser's 51 activities cause it to be in danger of violating a constraint threshold set by the advertiser, the content server software 53 could choose to place a different advertiser's link on the web pages that a browser 51 is viewing and/or stop charging for the activities of that browser 51.

### Repeat Metric Protocol

In yet another embodiment of the invention, the system 20 implements a Repeat Metric Protocol. The concept behind this protocol is to identify browsers 51 that predominately click on advertisements from a small number of web sites. This protocol is more expensive in terms of data storage than the previous protocols. The protocol is implemented by causing the content server software 53 to record the number of times that the browser 51 clicks on an advertisement on a website during at least one time period. After the expiration of the time period, the content server software 53 prepares summary data and places it in the receipt 74. This summary data may contain the length of the time period and, for the web sites on which the advertiser's Internet advertisements were clicked most frequently, the number of clicks. For example, if the time period was one week, then at the end of that week the content server software 53 could update the receipt with information “W,50,32,20” which would indicate that during the last week the browser 51 clicked on fifty of the advertiser's Internet advertisements on one web site, thirty-two on another web site, and twenty on a third website. However, the content server software 53 could be designed to return a percentage of the total number of advertisements clicked by that browser 51 during the time period which were related to the advertiser. Further, the content server software could update the receipt with a number (e.g., “10”) indicating that during the last week, the browser 51 clicked on ten different web sites more than a certain number of the advertiser's Internet advertisements (e.g., 100).

In another embodiment, the content server software 53 may record the number of times that the browser 51 clicks on an advertisement on a website over multiple time periods (e.g., hours, days, and weeks). After the expiration of the one or more of the time periods, the content server software 53 prepares the summary data regarding the number of times that an advertiser's Internet advertisements were clicked on the same web site and places that information in the receipt.

In still another embodiment, the repeat metric protocol may recognize that certain web sites which display advertisements are affiliated with one another because they share the same information (e.g., same or similar payee names, geographic proximity of check mailing addresses, and/or geographic proximity of check cashing facilities or depository bank used). These affiliated web sites may be combined for the purposes of the Repeat Metric Protocol such that advertisement clicks on any affiliated web site are treated as being from the same web site.

The commercial server software 57 extracts this information from the receipt 73 as described above and examines the number of times that the user has clicked on its advertisements on a particular web page. If it appears that the browser 51 is using a small number of web sites to repeatedly click on its advertisements, the advertiser can alert the content server that it has identified suspicious browser 51 activity. In addition, the advertiser may establish a constraint threshold for the number of times that its advertisements may be clicked by a particular browser 51 on any one web page over a predetermined time period. The content server software 51 can then detect when a particular browser's 51 activities will violate those thresholds and place a different advertiser's links on the web pages for that browser and/or stop charging for advertisements that are clicked by that browser.

### Maximum Clicks Per Time Metric Protocol

In still another embodiment of the invention, the system 20 implements a Maximum Clicks Per Time Metric Protocol. With this metric, the system 20 limits the number of times that a particular browser 51 can click on an ad within a given time period. The unit of time can be set to any desired amount, for example per any number of seconds minutes, hours, days, weeks, months, etc. The time period may begin at a point when a browser clicks on an ad, or the time period might begin at a predetermined time (e.g. midnight of a given day in a particular time zone) and continue until the time elapses (for example, for twenty-four hours, that is, until the following midnight).

In one embodiment, the mutating cookie 71 includes information regarding a plurality of recent clicks (e.g. the last thirty-two clicks), from which the Clicks Per Time can be determined. In one embodiment, the system 20 uses this information to determine a rate of clicking and compares this to a rate calculated from the Maximum Clicks Per Time. For example, if information about only the last thirty clicks is stored in the mutating cookie 71 and the user sets a Maximum Clicks Per Time of sixty clicks per hour, then the information regarding the last thirty clicks can be used to determine a per hour rate for assessing the Metric.

Thus, if an advertiser has set the Maximum Clicks Per Time Metric to one per day, then a particular browser will only be permitted to click on the advertiser's ads once each day. In practice, after the advertiser's ad has been clicked on by a particular browser the maximum number of times in a given time period (in this case, once in a day), then the advertiser's ad will not be delivered to or displayed on that browser until the next time period begins.

To implement the Maximum Clicks Per Time Metric, in one embodiment the content server software 53 uses the table 105 of unencrypted cookie identifiers 83 to store the number of times that a given ad has been clicked on by a browser within the particular time period as well as the times that each ad click occurs. In conjunction with the Ad Click Protocol, the number of times the browser 51 has clicked on an ad is updated in the lookup table 105. During the Ad Presentation Protocol, the table is checked for a particular ad or advertiser before presenting an ad, to make sure that the ad or advertiser has not exceeded the preset Maximum Clicks Per Time. If the number of times that the ad has been clicked on equals the Maximum Clicks Per Time, then the particular ad is not displayed on that browser 51 until the time period is reset. When the time period expires for a particular ad, the counter associated with that ad is reset in the table 105. In one embodiment, the Maximum Clicks Per Time Metric is applied to each ad separately.

In another embodiment, the Maximum Clicks Per Time Metric is applied collectively to all of the ads for a given advertiser, so that if a browser 51 clicks on any ad for the advertiser during the time period, none of the advertiser's ads will appear until the time period expires and a new time period begins.

### Maximum Number of Clicks Metric

The Maximum Number of Clicks Metric is a variation of the Maximum Clicks Per Time Metric, insofar as the time period is not reset. Thus, if a given browser clicks on an ad the maximum number of times determined by the advertiser, that ad will not be delivered or displayed on that browser any more. In one embodiment, once the maximum number of ad clicks has been reached for any ad or combination of ads from the advertiser, no more ads from that advertiser will be delivered or displayed to that browser.

### Minimum Unit of Time Per Ten Clicks Metric Protocol

In yet another embodiment of the invention, the system 20 implements a Minimum Unit of Time Per Ten Clicks Metric Protocol. A characteristic of a potentially malicious browser is the high frequency with which ads are clicked on in a given period of time, relative to a casual user who may click on ads less frequently. Thus, an advertiser may choose not to have her ads displayed on a browser that clicks on ads with what the advertiser feels is a suspiciously high frequency. For example, the advertiser might select twenty-four hours as the minimum unit of time for ten clicks, such that a browser that clicks on ads at a higher frequency will not display an ad from that advertiser.

In one embodiment the system 20 determines the frequency at which a particular browser has been clicking on ads by analyzing data pertaining to the Ad Click Protocol, where the data is encrypted and stored in the mutating cookie 71. In other embodiments, the system 20 uses information that is stored in the memory module 610b of the content server 22 instead of, or in addition to, the information in the mutating cookie 71, to determine the frequency with which a browser has been clicking on ads. If, for example, a browser has clicked on its last ten ads in the space of one hour, and an advertiser has set the Minimum Unit of Time Per Ten Clicks to be twenty-four hours, then the advertiser's ads will not be displayed to that particular browser.

In other embodiments, the Minimum Unit of Time Per Ten Clicks can be set to any desired number of seconds, minutes, hours, days, weeks, etc. Furthermore, in other embodiments, the metric can be set for a greater or lesser number of clicks besides ten.

### Click Variance Metric Protocol

In another embodiment, the system 20 implements a Click Variance Metric Protocol. A characteristic of certain malicious or fraudulent web users is that they only click on ads from one or a limited number of advertisers, for example as part of a so-called “click farm.” Thus, the Click Variance Metric Protocol assesses what percentage of a browser's total number of ad clicks are on a particular advertiser's ads.

Using the Click Variance Metric Protocol, an advertiser can set a threshold for a maximum percentage of a browser's total clicks on the advertiser's ads that the advertiser is willing to accept from the browser. If a given browser tends to select the advertiser's ads above a rate that the advertiser considers suspicious (e.g. if more than 25% of the ad clicks on the browser are on the advertiser's ads), then the Click Variance Metric Protocol prevents the advertiser's ads from appearing on the browser.

In some cases, the browser 51 may only have clicked on a small number of ads (e.g. two), with the result that the percentage of the advertiser's own ads that have been selected may appear artificially high due to the low sample number. Therefore, the Click Variance Metric Protocol includes a minimum number of clicks option that the advertiser can set which suspends use of the Click Variance Metric Protocol until the browser 51 has clicked on the minimum number of ads. For example, the advertiser may set the minimum number of clicks to twenty, with the result that the Click Variance Metric Protocol will not be employed unless the browser 51 has previously clicked on at least twenty ads.

In one embodiment, the Click Variance Metric Protocol is implemented using the Ad Presentation Protocol. After the content server software 53 has been contacted by the browser 51 and has obtained and analyzed all of the information available regarding the recent activity of the browser 51, the Click Variance Metric Protocol is executed in order to determine what percentage of the browser's ad clicks are targeted at the advertiser's ads. If the percentage is at or below the maximum percentage set by the advertiser, then the Ad Presentation Protocol will place the ad on the browser 51; otherwise, the ad will not be placed. If the browser 51 has not generated the minimum number of ad clicks, the Click Variance Metric Protocol will not be used to determine ad placement.

In another embodiment, the Click Variance Metric Protocol will measure the variance in the advertisers selected by the browser. In this instance, if a browser clicks on a particular advertisement a disproportionate number of times relative to other advertising clicks, it will be deemed fraudulent. The protocol works exactly as above except the particular advertisements being clicked on are used in the calculation.

### Maximum Number of Browsers Per IP Address Protocol

In still another embodiment, the system 20 implements a Maximum Number of Browsers Per IP Address Protocol. While there are legitimate reasons for multiple browsers to be sharing a single Internet Protocol (IP) address (e.g. multiple browsers using a publicly-accessible wireless connection at a location such as a library or coffee shop), having multiple browsers sharing the same IP address is also an indicator of a possible fraudulent ad clicking facility, i.e. a “click farm.” Thus, more cautious advertisers and/or advertisers with a more modest online advertising budget can limit their exposure to potentially fraudulent clicking by limiting the placement of ads with browsers that are sharing an IP address. For example, a more cautious advertiser or an advertiser that is not expecting a large volume of web traffic may set the Maximum Number of Browsers Per IP Address at one. While this may occasionally prevent an ad from being displayed to a legitimate user, certain advertisers would prefer to take that chance compared to the possibility of having their advertising budget consumed by potentially meaningless displays and/or clicks.

In one embodiment the Maximum Number of Browsers Per IP Address is implemented in conjunction with the Ad Presentation Protocol. As ads are delivered to various browsers, the content server software 53 stores the IP address of each browser in the lookup table 105. Subsequently, before the content server software 53 selects another ad to deliver to another browser, the content server software 53 first checks the lookup table to determine whether and how many other browsers are using the same IP address. If another browser is already using the IP address, then the content server software 53 compares the number of browsers that are using the same IP address to the advertiser's Maximum Number of Browsers Per IP Address to determine whether the Maximum Number has been exceeded. If the Maximum Number of Browsers Per IP Address has not been exceeded, then the ad is delivered to the browser, and the browser's IP address and other information are recorded accordingly, including in the lookup table 105.

In addition to the various metrics discussed above, which help distinguish malicious or fraudulent ad clicking from legitimate consumer interest, the system 20 may also include utilities such as a Budget Optimizer, a Maximum Cookie-less Clicks Per Day Protocol, a Sandbox Mode, a Transaction Marking Tool, a Case Study Tool, and a Data Mining Tool, each of which is described below.

### Budget Optimizer

In still another embodiment, the system 20 provides a Budget Optimizer utility to enable an advertiser to spread out an advertising budget over a desired time interval. For example, the advertiser may want to make sure the ads occur with a steady frequency over the course of the day in order to avoid spending a daily advertising budget in a few hours, for example.

Each advertiser may have a different manner of paying for ads, for example the advertiser may pay for each ad that is displayed independent of whether the ad is clicked on. Alternatively, the advertiser may only pay if the ad is actually clicked on. Finally, ads may be paid for based in part on the number of times the ad is displayed (sometimes called “impressions”) with an extra payment for each ad that is actually clicked on. The Budget Optimizer utility has access to all relevant ad billing information so that budgeting can be performed correctly. Billing information may be stored in any location that is convenient and preferably secure from unauthorized access. In one embodiment the billing information for a particular ad and/or advertiser is stored in the lookup table 105 associated with the content server 22 and content server software 53. In another embodiment, the billing information is stored in the receipt sent directly to the advertising proxy.

The Budget Optimizer utility, which in one embodiment is implemented within the content server software 53, monitors the frequency of ad placement and ensures that the placement of the ads, and thus the advertising budget, is spread out over the desired time interval as evenly as possible. In one embodiment, the Budget Optimizer simply divides the budget and time interval into smaller increments and makes sure that the relative fraction of the budget is not exceeded during any time increment. For example, the advertiser may want to spend one hundred dollars on ad placements during a time interval of one day. In that case, the Budget Optimizer may limit ad placements to produce an average budget of approximately four dollars per hour over the course of the twenty-four hour day.

In one embodiment, the Budget Optimizer is invoked in conjunction with the Ad Presentation Protocol. Before determining whether a particular ad will be served to a browser 51, the content server software 53 first runs the Budget Optimizer utility to verify that the budget for the particular advertiser has not been exceeded for the given time period and that delivering the new ad would not cause the budget to be exceeded, taking into account the cost of placing the ad as well as any possible extra charges that could be incurred if the browser 51 clicks on the ad.

In various embodiments, the Budget Optimizer will average out the budget on time increments that are larger or smaller than one hour to produce a relatively even distribution of advertising, for example every several hours or over increments of a fraction of an hour, e.g. every four hours, every two hours, every fifteen minutes, etc. Furthermore, in other embodiments an advertiser can choose to budget advertising time over less than a twenty-four hour interval, for example during a particular ten-hour period or any other period that the advertiser designates.

Given that the full amount of the budget may not be used during some time increments, the Budget Optimizer may recalculate the average advertising budget per time increment at the end of each time increment, dividing the remaining advertising budget by the remaining number of time increments and making sure that the new per-increment advertising budget is not exceeded during any increment.

In another embodiment, the Budget Optimizer maintains a running average of advertising costs. For example, in a twenty-four hour budgeting interval the running average may average together the advertising expenditures using a window of the previous four hours to assess whether a certain target hourly rate of advertising has been met or exceeded. Calculating hourly advertising expenditures based on a running average smoothes out uneven patterns of advertising activity, e.g. a large increase of activity at lunch time or in the evening with lower activity levels in between. Again, the Budget Optimizer can recalculate the target per-hour advertising budget at the end of each time increment based on the remaining budget and the number of time increments remaining in the time interval.

Other time intervals besides twenty-four hours and other time increments besides one hour can be used, as discussed above. In addition, the window of time to use for calculating a running average can be any length of time, typically longer than the length of a single time increment and shorter than the overall time interval.

In other embodiments, the Budget Optimizer averages the budget on all time increments up to twenty-four hours. In these embodiments, the current budget remaining is computed as half the daily budget minus a weighted sum of all payments made in the past twenty-four hours. The weight of each payment is the fraction of the day that expired before the payment was made.

### Maximum Cookie-less Clicks Per Day Protocol

In another embodiment, the system 20 implements a Maximum Cookie-less Clicks Per Day Protocol. Many of the metrics and other analytical tools disclosed herein depend to a greater or lesser extent on the availability of a transactional history associated with a particular browser. This transactional history is maintained through the use of mutating cookies 71, as discussed herein, which uniquely identify a browser and store information about that browser's recent ad-related activities. However, a user who is determined to defeat the system 20 may set his browser to refuse cookies or may delete the cookies some time after they are generated.

However, when the system 20 encounters a browser that does not have a cookie associated therewith, it is also possible that the cookie-less browser represents a genuine first-time user of the system 20. Nevertheless, a particular advertiser may want to limit exposure to cookie-less browsers due to the possibility that such browsers have been intentionally made cookie-less to avoid detection of click-fraud activities.

In one embodiment, the Maximum Cookie-less Clicks Per Day Protocol is implemented during the Ad Presentation Protocol. Although the goal is to limit the number of cookie-less clicks, the analysis of whether a particular browser has a cookie and whether a given advertiser may accept another cookie-less click must be made before an ad is actually served to the browser 51. During the Ad Presentation Protocol, the content server software 53 will detect whether there is a cookie associated with the browser 51 that has requested an ad to be served. If there is no cookie associated with the browser 51, then before an ad from a particular advertiser is sent to the browser 51, the content server software 53 will first determine how many cookie-less browsers have been served for that advertiser that day and also what the advertiser has set as a limit for cookie-less browsers for that day. If the advertiser's number of cookie-less browsers has not been met for the day, then the ad can be served to another cookie-less browser. If the advertiser's limit for cookie-less browsers has been met for the day, then that advertiser's ad will not be served and instead another advertiser's ad will be considered.

In other embodiments, the Maximum Cookie-less Clicks can be set for other time periods, such as any number of seconds, minutes, hours, days, weeks, months, etc. For any length of time, the time period can begin at a preordained time (e.g. midnight), or alternatively the time period may begin whenever the first cookie-less click is encountered.

### Sandbox Mode

In another embodiment, the system 20 permits a browser 51 to be in a Sandbox Mode. Sandbox Mode allows an operator of a web site containing placed ads to view the ads on the web site without incurring charges or generating revenue for those ads. This permits the operator of the web site to review the ads that are placed on the site to determine whether a competitor's ads are appearing on the web site, without the web site operator being accused of committing click fraud. When the web site is in Sandbox Mode, the parties whose ads appear on the web site while the browser 51 is in Sandbox Mode will not be charged for placement of the ads and/or clicks on the ads, nor will the web site operator receive compensation for displaying the ads.

In one particular embodiment, the web site operator switches a browser to Sandbox Mode by selecting an appropriate option from a menu or other parameter-setting mechanism. When the browser 51 has entered Sandbox Mode, a flag 72 (FIG. 4B) is set in the mutating cookie 71 that is associated with the browser 51 to signal the appropriate servers that the ads will not be billed to the respective advertisers. For example, the flag 72 may be a variable whose value is usually “1” but when it is set to “0” it places the browser 51 in Sandbox Mode. In addition, the mutating cookie 71 may also contain the address of one or more web sites that are in Sandbox Mode and accordingly will not generate charges for ad clicks. When the flag 72 is set accordingly for Sandbox Mode, a server such as the content server 22 (via the content server software 53) which accesses the cookie 71 will present ads to the browser 51 but will not charge the advertisers for the ads or compensate the web site operator for the placement of the ads. Nonetheless, the placement of ads still occurs in the same manner as would happen if the ads were paid for, in order to demonstrate to the web site operator the kinds of ads that appear on the web site.

### Transaction Marking Tool

In one embodiment, the system 20 includes a Transaction Marking Tool. The Transaction Marking Tool identifies the browsers 51 that visit an advertiser's web site and makes purchases or otherwise interacts with the web site. At some point in the transaction, which in one embodiment is when an order is confirmed, the Transaction Marking Tool obtains the browser's mutating cookie 71, evaluates the cookie, and adds information about the browser 51 and its purchase to a report for the advertiser. The information about which browsers 51 end up making purchases on the advertiser's web site can be linked to each browser's ad clicking and other behaviors, allowing the advertiser to fine-tune the various metrics to bring in more customers.

In one embodiment, the Transaction Marking Tool is implemented by inserting either a JAVA or PHP script into the appropriate web page on the advertiser's web site, for example on the order confirmation page that is displayed after a transaction is completed.

### Case Study Tool

In another embodiment, the system 20 implements a Case Study Tool. The Case Study Tool presents different sets of configurations of the metrics and utilities for different types of web advertisers, e.g. for High Volume web retailers, Low Volume web retailers, and retailers who simply want to maintain a limited Web Presence (FIG. 7F). The Case Study Tool lists values for the different parameters associated with the metrics and utilities corresponding to the various types of web retailers.

### Data Mining Tool

In still another embodiment, the system 20 implements a Data Mining Tool. The Data Mining Tool analyzes information associated with accepted and denied ad placements to advise the advertiser of the effects of changing the parameters related to the metrics and/or utilities. In various embodiments, the system 20 can analyze the fields in the mutating cookies 71 and/or a log of such cookie fields that is kept on a server to predict what would happen if the various parameters were changed, e.g. made more or less stringent. For example, if an advertiser were to agree to present ads to browsers having a higher rate of clicks per unit time (e.g. 7), then the system 20 can indicate to the advertiser how many more of the advertiser's ads would have been displayed, based on past behavior.

As should be apparent from the above, embodiments of the invention provide, among other things, methods of enhancing the integrity of Internet advertising. Embodiments of the invention have been described using exemplary protocols such as IP, HTTP, and others, but other protocols could be used. Various features and embodiments are set forth in the following claims.

What is claimed is:

1. A method for transferring state information between a client device and a server, the client device being configured to select content, and the server having a memory module and being configured to store referenced content and to transmit referenced content to at least one client device, the method comprising:
receiving a request on the server from the client device, wherein the request includes the state information from the client device;
detecting whether the state information has previously been received by the server;
updating the state information; and
transmitting a response including the updated state information to the client device.

2. The method as claimed in claim 1, wherein the request includes a first identifier associated with the state information and wherein the response includes a second identifier associated with the updated state information.

3. The method as claimed in claim 1, wherein the state information comprises a receipt which is indicative of usage history of the client device.

4. The method as claimed in claim 3, wherein the receipt is analyzed by the server to determine whether an advertisement will be transmitted to the client device.

5. The method as claimed in claim 4, wherein the summary information comprises a number of ad clicks by the client device over a period of time wherein a rate of clicks per time can be calculated, such that if the rate of ad clicks per time by the client device exceeds a predetermined rate, an advertisement is not delivered to the client device.

6. The method as claimed in claim 4, wherein the summary information comprises a total number of ad clicks by the client device, such that if the total number of ad clicks by the client device exceeds a predetermined number, an advertisement is not delivered to the client device.

7. The method of claim 1 wherein the request further comprises a counter value, such that detecting whether the state information has previously been received by the server comprises determining whether the counter value has changed since a previous time that state information was received from the client device.

8. The method of claim 7 wherein the state information is encrypted.

9. The method of claim 8 wherein the content comprises one or more advertisements.

10. The method of claim 7 wherein the counter is transmitted with the request using at least one of a cookie, an HTML GET command, and an HTML POST command.

11. A method for transferring encrypted data between a client device configured to select advertisements by the use of a user agent and a server configured with a memory module and to store linked advertisements and transmit linked advertisements to at least one client device, the method comprising:
receiving a request and encrypted data from the client device;
decrypting the encrypted data using a first key stored in the memory module of the server to produce unencrypted data;
updating the unencrypted data with information regarding at least one of the user agent, the client device, and the linked advertisement;
generating a second key on the server and using the second key to encrypt the updated unencrypted data instead of the first key;
encrypting the updated unencrypted data using the second key to produce re-encrypted data; and
transmitting a response and the re-encrypted data to the client device.

12. The method as claimed in claim 11, further comprising the steps of:
generating a first identifier and associating it with the first key;
receiving the first identifier on the server as part of the request and using the first identifier to locate the first key in the server's memory module; and
decrypting the encrypted data on the server using the first key to produce the unencrypted data.

13. The method as claimed in claim 12, further comprising:
generating a second identifier and associating it with the second key;
storing the second key and the second identifier on the memory module of the server such that the second identifier can be used to locate the second key; and
transmitting the second identifier and the re-encrypted data to the client device.

14. The method as claimed in claim 13, further comprising:
encrypting the second identifier; and
transmitting the encrypted second identifier to the client device as part of the response.

15. The method as claimed in claim 11, further comprising storing at least one key and an associated identifier in a lookup table in the memory module of the server.

16. The method as claimed in claim 15, further comprising deleting the at least one key from the lookup table after the at least one key is located using the associated identifier.

17. The method as claimed in claim 12, wherein the encrypted data and at least one identifier are received by the server in the form of a mutating cookie.

18. The method as claimed in claim 11, wherein the unencrypted data comprises a receipt.

19. The method as claimed in claim 18, further comprising analyzing the receipt to formulate the response to transmit to the client device.

20. The method as claimed in claim 11, further comprising:
configuring the encrypted data to have a first counter; and
incrementing the first counter each time that the user agent requests content that contains linked advertisements stored on the server.

21. The method as claimed in claim 20, further comprising:
configuring the encrypted data to have a second counter; and
incrementing the second counter each time that the user agent selects a linked advertisement transmitted to the client device by the server.

22. A method of transferring information between a first server and a second server, the first server configured to store referenced content and to transmit referenced content to at least one client device, the method comprising:
providing state information;
transmitting a first request and the state information to the first server in response to the client device;
receiving the first request and state information on the first server; and
transferring the state information to the second server.

23. The method as claimed in claim 22, wherein the referenced content is a linked advertisement.

24. The method as claimed in claim 23, wherein the state information comprises a mutating cookie.

25. The method as claimed in claim 24, wherein the state information further comprises a receipt.

26. The method as claimed in claim 25, wherein the state information further comprises encrypted information from the at least one client device.

27. A method of transferring information between a first computer and a second computer, the first computer configured to store linked advertisements and to transmit linked advertisements to at least one client device, the method comprising:
the first computer receiving a mutating cookie from the client device, wherein the mutating cookie comprises encrypted information;
receiving the first request and mutating cookie on the first computer;
decrypting the encrypted information included in the mutating cookie on the first computer to create unencrypted data;
generating a receipt comprising information pertaining to at least one of the client device, the first computer, and the unencrypted data; and
transferring the receipt to the second computer.

28. The method as claimed in claim 27, further comprising:
generating an identifier on the first computer and associating the identifier with the receipt;
transmitting a first response and the identifier to the client device from the first computer;
receiving a second request and the identifier on the second computer from the client device;
transmitting a third request and the identifier to the first computer from the second computer;
receiving the third request and the identifier on the first computer;
retrieving the receipt from the memory module of the first computer using the identifier;
transmitting a second response and the receipt to the second computer;
the second computer analyzing the receipt and determining whether an advertisement should be delivered to the client device.

29. The method as claimed in claim 27, wherein generating a receipt includes compiling summary information from the unencrypted data.

30. The method as claimed in claim 27, wherein generating a receipt includes configuring the receipt to include a first counter and a second counter.

31. The method as claimed in claim 30, further comprising determining a ratio of a value of the first counter to a value of the second counter.

32. The method as claimed in claim 31, further comprising
transmitting a notification from the second computer to the first computer if the ratio exceeds a predetermined value.

33. The method as claimed in claim 29, wherein the summary information comprises an amount of time that a first advertisement is displayed on the at least one client device, such that if said time is less than a predetermined duration, a second advertisement is not delivered to the at least one client device.

34. The method as claimed in claim 29, wherein the summary information comprises an average amount of time between delivery of advertisements to the at least one client device, such that if said average amount of time is less than a predetermined duration, an advertisement is not delivered to the at least one client device.

35. The method as claimed in claim 29, wherein the summary information comprises a summary of at least one of a number or percentage of advertisements from an advertiser that were selected by the at least one client device, such that if the at least one of a number or percentage exceeds a predetermined amount, a new advertisement from the advertiser will not be delivered to the at least one client device.

36. The method as claimed in claim 29, wherein the summary information comprises a number of ad clicks by the at least one client device over a period of time wherein a rate of clicks per time can be calculated, such that if the rate of ad clicks per time by the at least one client device exceeds a predetermined rate, an advertisement is not delivered to the at least one client device.

37. The method as claimed in claim 29, wherein the summary information comprises a total number of ad clicks by the at least one client device, such that if the total number of ad clicks by the at least one client device exceeds a predetermined number, an advertisement is not delivered to the at least one client device.

38. The method as claimed in claim 29, wherein the summary information comprises an amount of time for the at least one client device to click on ten ads, such that if the amount of time to click on ten ads is less than a predetermined amount of time, an advertisement is not delivered to the at least one client device.

39. The method as claimed in claim 29, wherein the summary information comprises a number of client devices that share an Internet Protocol address, such that if the number is greater than a predetermined level, an advertisement is not delivered to the client devices having the Internet Protocol address.

40. The method as claimed in claim 29, wherein the summary information comprises whether or not the at least one client device has valid state information such that if a combined number of client devices that do not have valid state information exceeds a predetermined value, an advertisement is not delivered to the at least one client device.

41. The method as claimed in claim 29, wherein the summary information comprises pricing information such that if the price is above a predetermined or calculated value, an advertisement is not delivered to the at least one client device.

42. The method as claimed in claim 27, wherein the first computer is a server.

43. The method as claimed in claim 27, wherein the second computer is a server.

44. A system for transferring encrypted data, the system comprising:
a first server having a memory module; and
a client device having a memory module and configured to run a user agent that is configured to select linked advertisements, the client device further configured to store encrypted data in the memory module, transmit a request and the encrypted data to the first server in response to the user agent, and receive encrypted updated data and store it in the memory module;
wherein the server is configured to
store and transmit linked advertisements,
receive the request and the encrypted data,
locate a first key in the memory module,
use the first key to decrypt the encrypted data to generate unencrypted data,
update the unencrypted data with additional information regarding the client device, the server, linked advertisements, or a combination of the same to create updated data,
use the first key to encrypt the updated data, and
transmit a response and the encrypted updated data to the client device.

45. The system as claimed in claim 44, wherein:
the client device is further configured to
store a first identifier in its memory module and transmit the identifier to the first server as part of the request,
receive a second identifier from the server as part of the response, and
store the second identifier in its memory module; and
the server is further configured to
associate a number of keys and identifiers with one another by storing them in the memory module of the server,
receive the identifier from the client device as part of the request,
use the identifier to retrieve one of the number of keys to decrypt the encrypted data, and
transmit the identifier to the client device in connection with the response.

46. The system as claimed in claim 44, wherein the server is further configured to generate a second key,
use the second key to encrypt the updated data; and
store the second key.

47. The system as claimed in claim 46, wherein:
the server is further configured to
generate a new identifier,
associate one of the first and second keys with the new identifier, and
transmit the new identifier to the client device as part of the response; and
the client device is further configured to
receive the new identifier from the server; and
store the new identifier in its memory module.

48. The system as claimed in claim 47, wherein at least one key and at least one identifier are stored in the memory module of the server in a lookup table.

49. The system as claimed in claim 48, wherein the server is configured to delete at least one key and the at least one key's identifier from the memory module of the server after the at least one key is used to decrypt the encrypted data.

50. The system as claimed in claim 48, wherein the encrypted data and at least one identifier are stored on the client device and transmitted from the client device to the server in the form of a mutating cookie.

51. The system as claimed in claim 50, wherein the encrypted data and at least one identifier are received by the server and transmitted from the server to the client device in the form of a mutating cookie.

52. A system for transferring data between a first server and a second server, the system comprising:
a client device configured to
run a user agent that is capable of selecting linked advertisements,
transmit a first request to the first server,
receive a first response and an identifier from the first server, and
transmit a second request and the identifier to the second server;
the first server configured to
store linked advertisements and transmit them to at least one client device,
receive the first request from the client device and generate data regarding the user agent, the client device, the first server, the linked advertisements, or a combination of the same,
generate an identifier and associate the identifier with the data in its memory module such that the data may be retrieved using the identifier,
transmit the first response and the identifier to the client device,
receive a third request and the identifier from the second server,
use the identifier to locate the data on its memory module, and
transmit a second response which contains the data to the second server; and
the second server configured to
receive the second request and the identifier from the client device,
transmit the third request and the identifier to the first server, and
receive the second response and the data from the first server.

53. A server for storing and transmitting linked advertisements, the server comprising:
a memory module configured to store linked advertisements and a number of keys;
an input/output module configured to transmit linked advertisements to one or more client devices, receive encrypted data from at least one of the one or more client devices which has selected a linked advertisement, and transmit encrypted updated data to the at least one client device over at least one communication link; and
a processor configured to a locate at lease one of the number of keys stored in the memory module, decrypt the encrypted data using the at least one of the number of keys, update the data with information regarding the client device, server, the linked advertisements, or combination of the same, and encrypt the updated data.

54. A client device for selecting linked advertisements, the client device comprising:
a memory module configured to store encrypted data;
an input/output module configured to receive encrypted data from a server over at least one communication link and to transmit encrypted data to at least one server over at least one communication link at the request of a user agent running on the client device and which is capable of selecting linked advertisements; and
a processor configured to run the user agent, cause the memory module to store encrypted data when it is received from the server, and cause the memory module to retrieve the encrypted data.

55. A method of determining the legitimacy of the selection of a linked advertisement, the method comprising:
implementing an advertisement presentation protocol, wherein the protocol includes transmitting a mutating cookie between a user agent and a content server;
configuring the mutating cookie to include encrypted data concerning the interactions between the content server and the user agent;
associating an unencrypted identifier with a cryptographic key for storing on the content server; and
exchanging the mutating cookie between the user agent and the server each time the browser visits a new web site.

56. A method of determining the legitimacy of the selection of a linked advertisement, the method comprising:
transmitting a cookie from a user agent to a content server;
updating information in the cookie at the content server;
generating a receipt configured for an advertiser, the receipt including information pertaining to activity of a user who selects a linked advertisement;
analyzing the receipt; and
generating an alert based on the analysis of the receipt.

57. The method of claim 56, wherein the cookie is a mutating cookie.
